(19) United States
(12) Patent Application Publication
(10) Pub. No.: US 2006/0248311 A1
(43) Pub. Date: Nov. 2, 2006

(54) Method and apparatus of dsp resource allocation and use

(76) Inventor: Earle Willis Jennings, Kensington, CA (US)

Correspondence Address: Earle Jennings, 8 Kenyon Avenue, Kensington, CA, 94708, US

(21) Appl. No.: 10/276,414

(22) PCT Filed: May 14, 2001
(86) PCT No.: PCT/US01/15541

§ 371 Date: Oct. 3, 2005

Related U.S. Application Data
(60) Provisional application No. 60/204,113, filed on May 15, 2000.
(60) Provisional application No. 60/215,894, filed on Jul. 5, 2000.
(60) Provisional application No. 60/217,353, filed on Jul. 11, 2000.
(60) Provisional application No. 60/231,873, filed on Sep. 12, 2000.
(60) Provisional application No. 60/261,066, filed on Jan. 11, 2001.
(60) Provisional application No. 60/282,093, filed on Apr. 6, 2001.

(51) Int. Cl. G06F 15/00

(52) U.S. Cl. 712/22

(57) ABSTRACT

Certain embodiments of the invention support the distribution and control of multiple instruction streams going to multiple steps of modules supporting arithmetic and memory, as well as method for numeric data processing optimizing non-additive functions and operations through a novel numeric representation and the use of novel ALU components to support numeric conversions and evaluations of non-additive functions.

This application claims priority from the following provisional applications filed with the United States Patent and Trademark Office:

Ser. No. 60/204,113, entitled “Method and apparatus of a digital arithmetic and memory circuit with coupled control system and arrays thereof”, filed May 15, 2000 by inventor, docket number ARITH001PR;

Ser. No. 60/215,894, entitled “Method and apparatus of a digital arithmetic and memory circuit with coupled control system and arrays thereof”, filed Jul. 5, 2000 by inventor, docket number ARITH002PR;

Ser. No. 60/217,353, entitled “Method and apparatus of a digital arithmetic and memory circuit with coupled control system and arrays thereof”, filed Jul. 11, 2000 by inventor, docket number ARITH003PR;

Ser. No. 60/231,873, entitled “Method and apparatus of a digital arithmetic and memory circuit with coupled control system and arrays thereof”, filed Sep. 12, 2000 by inventor, docket number ARITH004PR;

Ser. No. 60/261,066, entitled “Method and apparatus of a DSP resource circuit”, filed Jan. 11, 2001 by inventor, docket number ARITH005PR; and

Ser. No. 60/282,093, entitled “Method and apparatus of a DSP resource circuit”, filed Apr. 6, 2001 by inventor, docket number ARITH006PR.

### TECHNICAL FIELD

This invention relates to digital signal processing engines, instruction processing mechanisms, arithmetic operational units of same, as well as circuitry generated based upon use of some or all of these elements.

### BACKGROUND OF INVENTION

Today, much of the growth in the planetary economy depends on rapid and reliable development of new products, many of which require Digital Signal Processing (DSP) hardware to solve the problems which attract customers to buy such products. These problems are often solved by a wide variety of digital filtering techniques, often based upon Finite Impulse Response (FIR) filtering including various Discrete Fourier Transform based algorithms as well as Discrete Wavelet Transform algorithms. Most of these response and transform functions are linear in nature. Many of these functions operate on a finite grid of data, frequently known as a data window.

While existing hardware vehicles provide vehicles for such algorithms, there are several central problems which are difficult to solve with existing solutions.

Many application systems need non-linear functions. Some commonly used arithmetic operations in engineering and applied science include but are not limited to the following: square roots, cube roots, division, trigonometric functions, powers of numbers, polynomial functions, rational functions, exponential functions, logarithms, and determinants.

These commonly used arithmetic operations have found significant application in at least the areas of graphics models, statistical and probabilistic tools, dynamical systems, flow simulations, control systems, transistor and circuit modeling and other nonlinear models.

Additionally, there are large applications in the areas of multimedia and image processing including the requirements of filling an HDTV screen with an MPEG stream and various medical imaging applications.

The cellular radio industry possesses a number of base station related applications including 911 call location determination and signal separation in high capacity situations. What is needed is arithmetic processing circuitry which can address at least these needs in a real-time fashion.

The above mentioned finite grids of data are often sampled in real-time by sensor devices. Each data sample can vary from as small as 6 bits per data sample to 17 or more bits per data sample. Usually, the data tends to be of fairly uniform size, the number of sample bits does not vary much, if at all, across a data grid. Most DSP hardware has a fixed input data size, usually a multiple of 8 or 9 bits. The consequence of this is that bits go unused. By way of example, in a device supporting only 8 and 16 bit data input, a 9 bit sample requires all 16 bits be used, even though only slightly more than 50% of the input bits are actively being used. Further, the data is often sampled at very high rates by multiple sensors, ranging from hundred of thousands of samples per second per sensor to a hundred million samples per second per sensor. What is further needed is a high speed capability to efficiently accept and process widely varying data sample widths.

Today, arithmetic-based models are in widespread use employing various fixed point and floating point numeric representations. There is a central problem associated with these representations, the accumulation of arithmetic errors. This is an architectural result of the limited structural capabilities of contemporary arithmetic processors. Such processors typically can only perform arithmetic of a fixed number of significant bits in a given instruction execution period. The consequence of this is that as calculations progress, additional precision is required, but not available. What is needed is arithmetic circuitry which can be readily configured to provide a wide range of precision for any given instruction sequence in a given instruction execution period.

By way of example, many real-time DSP applications possess the following common constraints. High speed input sample rates, often on the order of 100K to 100 Million samples per second. High output result rates, due to the prohibitive expense of storing these samples for longer than a few milliseconds to a few seconds. Data sample sizes varying from 6 to 16 bits per sample, with a concomitant requirement to preserve or improve the signal to noise ratio from input sensors to internal use of these samples. Many of these applications are developed against a further constraint of short time-to-market requirement.

Contemporary approaches to the performance problems of DSP include standard instruction processors, VLIW processors and reconfigurable computers. Standard instruction processors can be further classified as embedded core DSP processors, Single Instruction Single Datapath (SISD) processors and Multiple Instruction Multiple Datapath (MIMD) processors. Commercial examples of mbedded core DSP processors include the DSP group Oak and Pine processors. Commercial examples of SISD processors include some of the components of the Analog Devices ADSP product line and products of the Texas Instrument 54XX DSP Family. Commercial examples of MIMD products include the high-end products of the ADSP product line. Commercial examples of VLIW processors can be found in the TI 60XX DSP product family.

There are at least two distinct performance bottlenecks which affect all or nearly all of the above mentioned approaches to arithmetic and instruction processing: the instruction fetch bottleneck and data access bottleneck.

The instruction fetch bottleneck is caused by the imbalance of memory access rate compared to instruction processing mechanisms. Various approaches to solving this problem include adding cache memories, which then put the balance in favor of memories. This leads to compensating by incorporating instruction decoders operating upon multiple instructions as found in super-scalar microprocessors. Such circuitry increases the instruction processing capability of a single instruction path device, by greatly increasing the relative size of the instruction decoding mechanism to the arithmetic processors, as well as increasing the complexity of verifying instruction set execution compliance. What is needed is a flexible instruction processing mechanism which can more efficiently utilize instruction memory bandwidth to drive the arithmetic processing circuitry.

The data access bottleneck often arises when memory is shared with other processes, such as the instruction fetching process mentioned above. The standard approach to minimizing this problem is the use of either separate memories or providing caches, which in many cases are specifically dedicated to data memory operations. While these approaches add to the availability of data for arithmetic processing, they do not address what the following major limitations found in all of the prior art. The prior art does not provide the user with direct control over the input data width, the internal or intermediate precision width, nor the output data width. What is needed is a way to provide the user of these circuits with direct control over input data with, internal or intermediate precision width and outut data width.

Today, VLIW architectures are available which show some flexibility, but are difficult to program due to complex, multiple-memory cycle instruction fetching mechanism, as well as having little or no flexibility regarding input data widths, internal/intermediate precision and output data widths.

Reconfigurable computers have been extensively researched since the 1990's, but have yet to have large scale commercial success. These computer have been largely constructed from arrays of FPGA's. They have tended to be very difficult to program, often requiring gate level or logic cell level programming, as opposed to support procedural computer language compilers. Such computer also tend to have problems with multiplication. While some FPGAs now contain cells supporting small multipliers, often 4 by 4 or 4 by 5 bit multipliers, when even a 16 by 16 bit multiplication is to be done, somewhere between 6 and 16 of these cells must be dedicated to that task.

Multipliers built this way do not lend themselves to ease of programming nor show themselves flexible in terms of changing input data width or output data width requirements. Most people require less development time to create numeric applications using procedural programming languages such as C or Java than using assembly language, much less a gate or function cell level definition language. The fact that it is possible to build a multiplier with an FPGA is not the problem system developers have to solve.

What is needed is a mechanism providing the user with direct control over the input data width, the internal/intermediate precision width, and the output data width while providing a wide range of arithmetic operations in an efficient fashion. What is further needed is a method of specifying such control and then generating efficient circuits satisfying those specifications. What is further needed is an architecture which provides standard procedural language compiler support both for mechanisms supporting user control of input data width, internal/intermediate precision and output data width. What is further needed is a target circuit compilation architecture providing automated support for procedural compilers specified and generated by such methods.

There are further problems in the organization of instruction processing mechanisms which significantly constrain performance due to the fixed configuration of internal operational resources. By way of example, the number of arithmetic processing resources available to prepare for a branch decision is fixed. However, high performance arithmetic-oriented applications often involve very large numbers of arithmetic operations being performed before any branching decisions need be made. When branching is to be performed, a number of relatively short operation sequences are usually needed to determine the flow of execution and control. What is needed is an instruction processing mechanism which can be optimally configured for both decision processes and computational sequences.

Today, multiple datapath architectures are either Single Instruction Multiple Datapath (SIMD) or Multiple Instruction Multiple Datapath (MIMD). However, there are times when a system optimally acts in one fashion, and other times when it optimally would perform in the other fashion. What is needed is an architecture supporting multiple datapaths in either an SIMD or MIMD mode, which can be rapidly reconfigured from one to the other.

There are additional problems facing the system designer intent upon making a new product: the system designer must often provide a complete systems solution, which often includes a package containing one or more printed circuits, which further contain integrated circuits performing numeric tasks within the package in normal operating modes. The system designer needs to be able to test the printed circuits containing the integrated circuits in operation as early in the design process as possible.

Additionally, while there have been various attempts to use logarithmic numeric notations to perform arithmetic operations, none of the known approaches are readily extensible to varying precision widths. Such notations tend to treat numbers as either floating point numbers possessing an exponent and mantissa, or as a fixed point number. Both mechanisms have decided problems when applied to the varying needs of systems design, where the notation must be useful across a large collection of numeric ranges. Floating point notations have fixed fields, which further tend to hide the most significant bit of the mantissa, rendering such a notation is inherently difficult to alter. Both approaches to number notations lack any obvious way to convert 0 into a logarithm of 0. What is needed is a numeric notation readily supporting logarithmic numbers as well as being readily scalable to support differing amounts of precision in a real-time environment.

To summarize, what is needed is arithmetic processing circuitry addressing the need for advanced, often non-linear functions based upon much more than linear arithmetic operations in a real-time fashion. Such operations include but are not limited to square roots, division, trigonometric functions, powers of numbers, polynomial functions, rational functions, exponential functions, logarithms, and determinants. What is needed includes the ability to efficiently accept and process widely varying data sample widths at high speeds. What is needed is arithmetic circuitry readily configured to provide a wide range of precision for any given instruction sequence in a given instruction execution period. What is needed is a flexible instruction processing mechanism which can more efficiently utilize instruction memory bandwidth to drive the arithmetic processing circuitry. What is needed is an instruction processing mechanism which can be optimally configured for both decision processes and computational sequences. What is needed is an architecture supporting multiple datapaths in either an SIMD or MIMD mode, which can be rapidly reconfigured from one to the other.

What is needed is a mechanism providing the user with direct control over the input data width, the internal/intermediate precision width, and the output data width while providing a wide range of arithmetic operations in an efficient fashion. What is further needed is a method of specifying such control and then generating efficient circuits satisfying those specifications. What is further needed is an architecture which provides standard procedural language compiler support both for mechanisms supporting user control of input data width, internal/intermediate precision and output data width. What is further needed is a target circuit compilation architecture providing automated support for procedural compilers specified and generated by such methods.

### SUMMARY OF INVENTION

Certain embodiments of the invention solve all the above mentioned problems found in the prior art.

Certain embodiments utilize partitionable datapath bit width units, which can be configured to provide a requested level of numeric precision. The partitionable datapath bid width units include at least memory arrays and ALUs, which can collectively be configured to specific bit widths supporting the requested level of numeric precision in both a normal numeric realm and a logarithmic numeric domain.

Certain embodiments of the invention represent a collection of numbers as having at least a minus-infinity as a special part of each represented number. These minus-infinity numbers act as annihilators in addition, so that minus-infinity plus anything else results in a minus-infinity in the special part of the represented result. Thus, the fact that zero multiplying anything in the normal numeric realms translates upon taking logarithms of both numbers. The logarithmic conversion of a zero yields a represented number with a minus-infinity. The exponential conversion of a represented number with negative-infinity in its special part yields a 0 result.

Represented numbers may further include a special-plus or special-minus in their special parts, further supporting preservation of the input number sign upon into the represented number and conversion back to output numbers. Note that this also requires that special-minus represented numbers, when added to special-minus represented numbers generate a represented number result with a special-plus. Special-plus added to special-plus results in a special-plus. When a special-minus number and a special-plus number are added, the result is a special-minus result.

This effects a logarithm of a first number added to the logarithm of a second number is essentially the same as the logarithm of the product of the first and second numbers. In the logarithm domain, functions can be calculated which are very computationally expensive in the normal realm of numbers. A level of efficiency previously unavailable in a programmable device of any kind is achieved by using at least some of the memories as table lookup mechanisms to approximately convert numbers between their logarithms, exponentials and other functions.

Certain embodiments of the invention include a method of using an array of computational resources containing at least one input-output resource, at least one datapath operational resource comprising: selecting the input-output resources to create an input-output access collection comprised of at least an input-output access parameter; and selecting the datapath operational resources based upon the input-output access collection to create a datapath operational resource allocation collection containing at least one datapath operation resource allocation.

This supports selecting input-output resources for optimal data bandwidth throughput. They also support selecting datapath operational resources for optimal datapath resource allocation operating on data traversing the selected input-output resources.

The computation resource array may contain at least one instruction propagating resource. The method may selecting the instruction propagating resources based upon the input-output access collection and the datapath operational resource allocation collection to create an instruction propagating configuration collection containing at least one instruction propagating configuration.

The computation resource array may further contain at least one instruction processing resource. Instruction processing resources may further be selected based upon the input-output access collection, datapath operational resource allocation and instruction propagating configuration.

The instruction processing resources may contain at least one instruction register. The computation resource array may further contain at least one instruction fetching resource. The method may include fetching using the instruction fetching resource to create a fetched instruction and loading the fetched instruction into the instruction register to create an instruction register state based upon the fetched instruction.

Certain embodiments of the invention include circuits generated by methods of this invention. They may be implemented using collections of one or more programmable logic devices, which may in turn include one or more programmable logic arrays and/or one or more Field Programmable Gate Arrays (FPGAs). They may be implemented as part or all of an integrated circuit, having been specified using a method of this invention and/or simulated based upon their specification. Their simulation may include implementations targeting logic hardware accelerators including programmable logic devices as execution elements.

Certain embodiments of the invention include an arithmetic module of multiple basic arithmetic circuits coupled to share several wire bundles including a first shared buss, a second shared buss and a third shared buss that synchronously execute either one or two instructions, depending upon a configuration register. The shared bus wire bundle state is determined in part by the configuration register. Each basic arithmetic circuit includes a basic arithmetic memory coupled with a basic arithmetic calculator.

### BRIEF DESCRIPTION OF DRAWINGS

FIG. 1 depicts a basic arithmetic processing unit 1400 comprised of a first memory circuit 1200 and a first ALU 1300 in accordance with certain embodiments of the invention;

FIG. 2 shows a refinement of FIG. 1 further depicting an input-output circuit 1100 coupled to the first memory circuit 1200 and a first ALU 1300 of basic arithmetic unit 1400;

FIG. 3 shows a refinement of FIG. 2 further depicting input-output circuit 1100 coupled to the first memory circuit 1200 and a first ALU 1300 and further coupled to a second memory circuit 1250 forming a basic arithmetic unit 1402, which is a refinement of basic arithmetic unit 1400;

FIG. 4 shows a refinement of FIG. 3 depicting input-output circuit 1100 coupled to the first memory circuit 1200 and a first ALU 1300 and coupled to a second memory circuit 1400 with additional interconnections forming a basic arithmetic unit 1402, which is a refinement of basic arithmetic unit 1400;

FIG. 5 shows a refinement of FIGS. 1, 2, 3 and 4 depicting input-output circuit 1100 coupled to multiple instances of basic arithmetic unit 1400;

FIG. 6 shows a refinement of FIG. 5 depicting a first input-output circuit 1100 coupled to multiple instances of basic arithmetic unit 1400 and a second instance of input-output circuit 1100;

FIG. 7 shows a detail diagram of an ALU circuit 1300 in terms of four interconnected instances of a second ALU circuit 1310 supporting carry propagation controlled by partitioning wire bundle 1002;

FIG. 8 shows a detail diagram of first ALU circuit 1300 in terms of eight interconnected instances of a second ALU circuit 1310 supporting carry propagation controlled by partitioning wire bundle 1002;

FIG. 9 depicts an arithmetic logic unit 1310 with multiple add-inputs presented to shifters and then added to generate an add-result;

FIG. 10 shows Arithmetic Process Array 3000 comprising at least one Arithmetic Processor 3002, each coupled with 3104 Instruction Memory 3200 and with 3106 Instruction Memory 3300;

FIG. 11A show a single column of coupled first memories 1210-i and ALU2 1310-i, where i=1 to 8;

FIG. 11B show four columns of coupled first memories 1210-i and ALU2 1310-i, where i=1 to 8;

FIGS. 12 to 16 show a configuration of instruction memories and MSRI[K] sufficient to perform a large number of realtime filtering and more sophisticated tasks upon an input stream of 8 or 9 bit samples;

FIG. 17A show a single column of coupled first memories 1210-i and ALU2 1310-i, where i=1 to 8, with two instructions memories 3200 and 3300 providing two instructions transmitted to each. Note that in other embodiments of the invention, i could range over a different range;

FIG. 17B show four columns of coupled first memories 1210-i and ALU2 1310-i, where i=1 to 8, with two instructions memories 3200 and 3300 providing two instructions transmitted to each.

FIGS. 18 to 20 show various configurations of PISRI's and their neighboring instruction memories;

FIG. 21 shows a high level data flow diagram of a two dimensional array block 1300 of ALU2 circuits 1310 and connecting datapaths between them by which data may be transported;

FIG. 22A depicts a flowchart performing a method of using an array of computational resources containing at least one input-output resource and at least one datapath operational resource;

FIG. 22B depicts a detail flowchart of user operation 2000 of FIG. 22A further performing selecting the instruction propagating resources based upon the input-output access collection and based upon the datapath operational resource allocation collection to create an instruction propagating configuration collection containing at least one instruction propagating configuration;

FIG. 23A depicts a detail flowchart of user operation 2000 of FIG. 22A performing selecting the instruction processing resources based upon the input-output access collection, the datapath operational resource allocation collection, and the instruction propagating configuration collection to create an instruction processing configuration collection containing at least one instruction processing configuration;

FIG. 23B depicts a detail flowchart of user operation 2000 of FIG. 22A further performing the method of using/operating the array of computational resources;

FIG. 24A shows a detail block diagram of an instruction memory 3200 comprised of instruction register 3600, branch processor 3700 and instruction memory array 3500; FIG. 24B shows a detail block diagram of an instruction memory 3200 extending the block diagram of FIG. 24A further comprised of instruction fetch mechanism 3800;

FIG. 25 shows a detail block diagram of an branch processor 3700 comprised of branch sequence register 3710, program counter 3730 and branch address look-up table 3720; and

FIG. 26 shows a detail block diagram of a branch processor 3700 extending the block diagram of FIG. 25 further comprised of cache manager 3740;

FIG. 27 depicts a high level system block diagram of a DSP Resource Circuit in accordance with certain embodiments of the invention;

FIG. 28 depicts a simplified floor plan of a layout of the DSP Resource Circuit of FIG. 27;

FIG. 29 depicts a preferred version of ALU 1400, as used in FIG. 28 and earlier Figures supporting configurations of its internal memories and system input 1002 emulating a multiplier-accumulator with local register bank;

FIG. 30 depicts a flowchart of a method of processing numeric data, which may be variously embodied;

FIG. 31 depicts a detail flowchart of operation 2222 of FIG. 30 further performing the arithmetic operation collection;

FIG. 32A depicts a detail flowchart of operation 2272 of FIG. 31 further adding;

FIG. 32B depicts a detail flowchart of operation 2282 of FIG. 31 further subtracting;

FIG. 33A depicts a detail flowchart of operation 2292 of FIG. 31 further exponentiating;

FIG. 33B depicts a detail flowchart of operation 2302 of FIG. 31 further logarithming;

FIG. 34A depicts a detail flowchart of operation 2442 of FIG. 33B further setting the special part of the log-result;

FIG. 34B depicts a detail flowchart of operation 2442 of FIG. 33B further setting the special part of the log-result;

FIG. 35A depicts a detail flowchart of operation 2292 of FIG. 31 further exponentiating;

FIG. 35B depicts a detail flowchart of operation 2302 of FIG. 31 further logarithming;

FIG. 36A depicts a detail flowchart of operation 2532 of FIG. 35B further determining whether the sign part of the first number is essentially equal to the negative-sign;

FIG. 36B depicts a detail flowchart of operation 2532 of FIG. 35B further determining whether the sign part of the first number is essentially equal to the negative-sign;

FIG. 37A depicts a detail flowchart of operation 2232 of FIG. 30 further log-converting the input number collection member;

FIG. 37B depicts a detail flowchart of operation 2232 of FIG. 30 further log-converting the input number collection member;

FIG. 38A depicts a detail flowchart of operation 2242 of FIG. 30 further exp-converting; and

FIG. 38B depicts a detail flowchart of operation 2242 of FIG. 30 further exp-converting.

### DETAILED DESCRIPTION OF DRAWINGS

As used herein a wire refers to a path connecting nodes of a circuit which carries a state between the connected nodes and/or refers to a resonant cavity propagating information in terms of state between the connected nodes. A wire may be made out of metal, an optical chamber, or a tunnel path through a molecular substrate. A wire bundle is a collection of at least one wire.

State as used herein refers to an element of a finite alphabet, which contains at least two symbols. These two minimal symbols relate to ‘0’ and ‘1’ as used in Boolean logic.

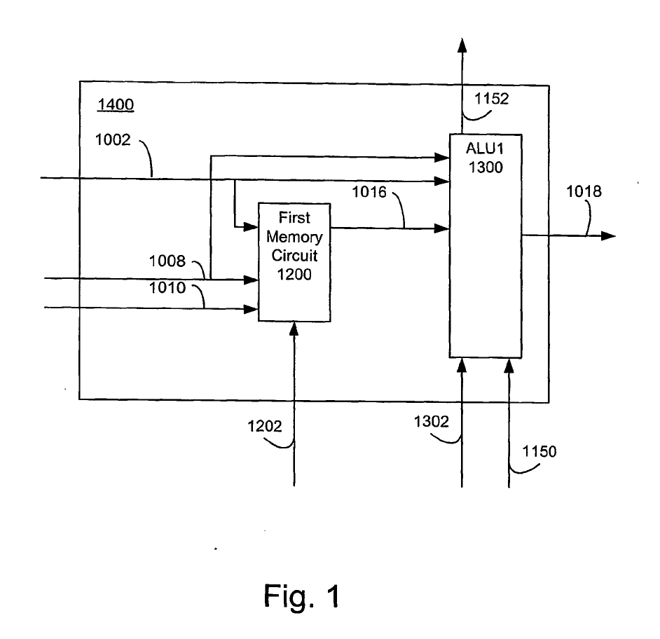

FIG. 1 depicts a basic arithmetic processing unit 1400 comprised of a first memory circuit 1200 and a first ALU 1300 in accordance with certain embodiments of the invention.

The basic arithmetic unit 1400 includes a partitioning wire bundle 1002 presented to first memory circuit 1200 and first ALU 1300. Input wire bundle 1008 is presented to first memory circuit 1200 and first ALU 1300. Input wire bundle 1010 is presented only to first memory circuit 1200. First memory instruction wire bundle 1202 is presented to first memory circuit 1200. First memory circuit 1200 generates signals for first memory output wire bundle 1016 presented to first ALU 1300. First ALU instruction wire bundle 1302 is presented to first ALU circuit 1300. First ALU 1300 receives a carry-in wire bundle 1150, first ALU instruction wire bundle 1302 and generates a carry-out wire bundle 1152 and further generates signals for first ALU output wire bundle 1018.

The basic arithmetic processing unit operates by receiving the signal state of partitioning wire bundle 1002, which determines the partitioning of the signaling of input wire bundle 1008, input wire bundle 1010, first memory output wire bundle 1016 and first ALU output wire bundle 1018, as well as first memory instruction wire bundle 1202, first ALU instruction wire bundle 1302 and carry-input wire bundle 1150. The received signal state of the partitioning wire bundle 1.002, further determines the operational partitioning of first memory circuit 1200 and first ALU circuit 1300 with regards to the signaling of input wire bundle 1008, input wire bundle 1010, first memory output wire bundle 1016 and first ALU output wire bundle 1018.

First memory circuit 1200 receives the signal state of partitioning wire bundle 1002, which determines the partitioning of the signaling of input wire bundle 1008, input wire bundle 1010 and first memory instruction wire bundle 1202. Partitioning wire bundle 1002 signal state is used by first memory circuit 1200 to determine from the signal state of first memory instruction wire bundle 1202 at least one of first memory local instructions to be executed. The first memory local instructions are executed by the first memory circuit 1200. First memory circuit 1200 asserts the signal state of first memory output wire bundle 1016.

First ALU 1300 receives the signal state of partitioning wire bundle 1002, which determines the partitioning of the signaling of input wire bundle 1008, first memory output wire bundle 1016, first ALU instruction wire bundle 1302 and the effect of the signal state of carry-input wire bundle 1150. Partitioning wire bundle 1002 signal state is used by first ALU circuit 1300 to determine from the signal state of first ALU instruction wire bundle 1302 of at least one of first first ALU local instructions to be executed. The first ALU local instructions are executed by the first ALU circuit 1300. First ALU circuit 1200 asserts the signal state of first ALU output wire bundle 1018.

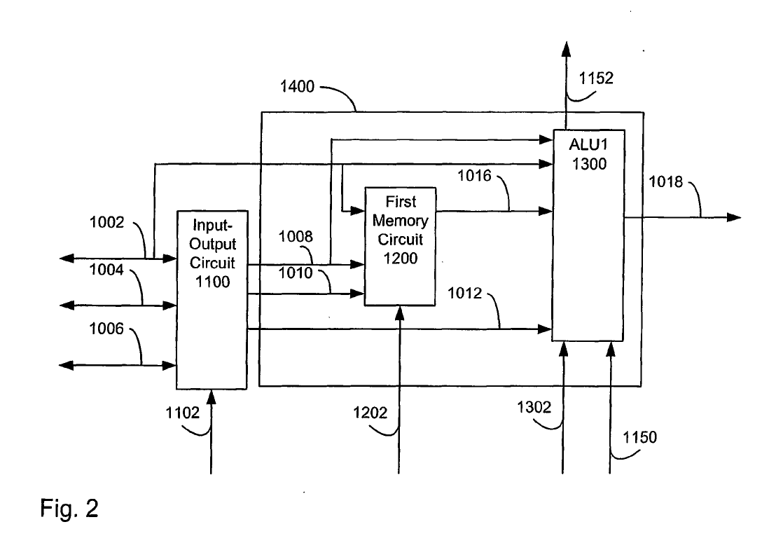

FIG. 2 shows a refinement of FIG. 1 further depicting an input-output circuit 1100 coupled to the first memory circuit 1200 and a first ALU 1300 of basic arithmetic unit 1400.

Note that FIG. 2 operates in much the same fashion as FIG. 1, excepting Input-output circuit 1100 acts as an interface between at least three external data bus wire bundles, 1004 and 1006 controlled by instruction wire bundle 1102 as well as partitioning wire bundle 1002 and creating the state on wire bundles 1008, 1010 and 1012.

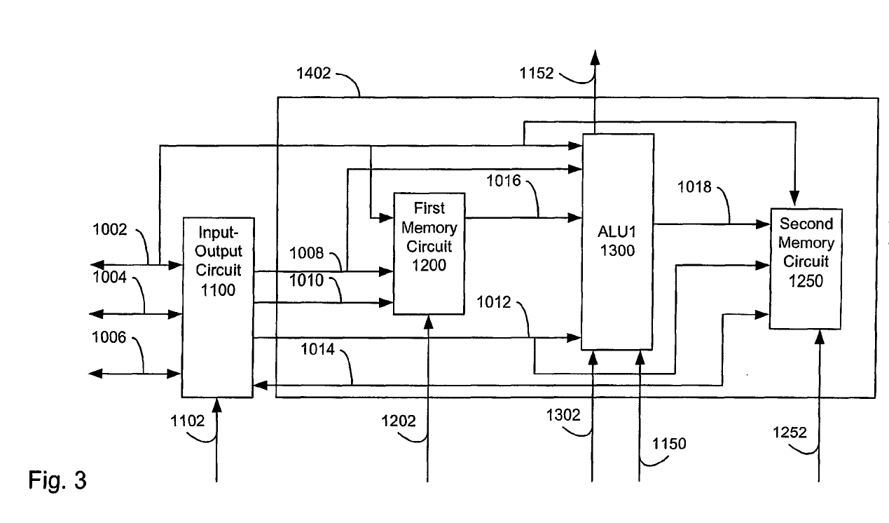

FIG. 3 shows a refinement of FIG. 2 further depicting input-output circuit 1100 coupled to the first memory circuit 1200 and a first ALU 1300 and further coupled to a second memory circuit 1250 forming a basic arithmetic unit 1402, which is a refinement of basic arithmetic unit 1400.

Note that FIG. 3 operates in a similar fashion to FIGS. 1 and 2 with regards to elements of similar reference numbers.

Second memory circuit 1250 may receive output 1018 from ALU 1300 as well as wire bundle 1014 from input-output circuit 1100 based upon partitioning wire bundle 1002. Second memory circuit 1250 may drive the state of wire bundle 1014. Second memory circuit 1250 may receive wire bundle 1012 from input-output circuit 1100.

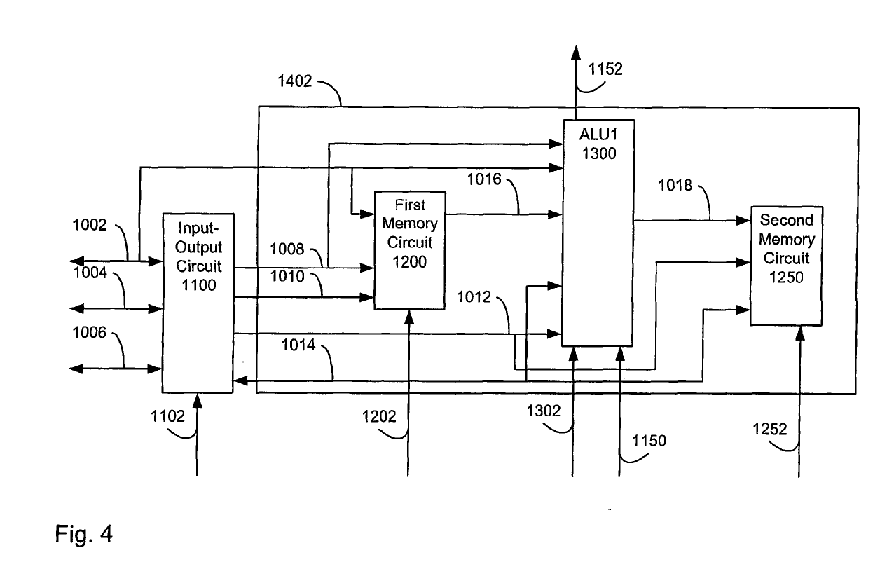

FIG. 4 shows a refinement of FIG. 3 depicting input-output circuit 1100 coupled to the first memory circuit 1200 and a first ALU 1300 and coupled to a second memory circuit 1400 with additional interconnections forming a basic arithmetic unit 1402, which is a refinement of basic arithmetic unit 1400.

Note that FIG. 4 operates in a similar fashion to FIG. 1, 2, and 3 with regards to elements of similar reference numbers.

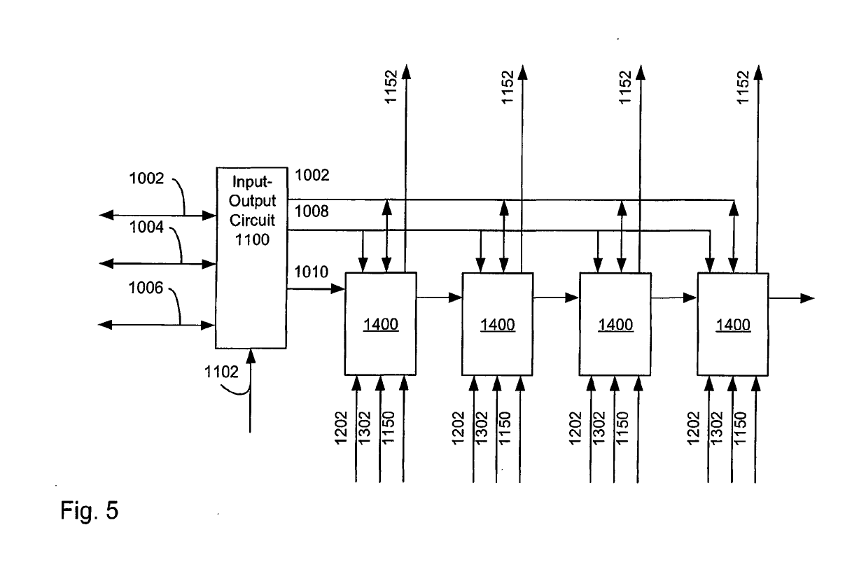

FIG. 5 shows a refinement of FIGS. 1, 2,3 and 4 depicting input-output circuit 1100 coupled to multiple instances of basic arithmetic unit 1400.

Basic arithmetic unit 1400 may at least be basic arithmetic unit 1402 as shown in FIGS. 2, 3 and 4.

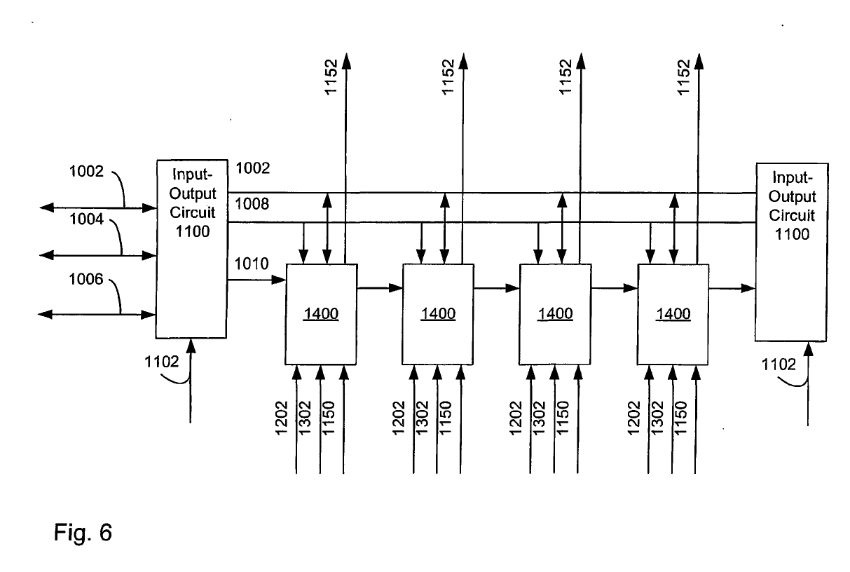

FIG. 6 shows a refinement of FIG. 5 depicting a first input-output circuit 1100 coupled to multiple instances of basic arithmetic unit 1400 and a second instance of input-output circuit 1100.

Basic arithmetic unit 1400 may at least be basic arithmetic unit 1402 as shown in FIGS. 2, 3 and 4.

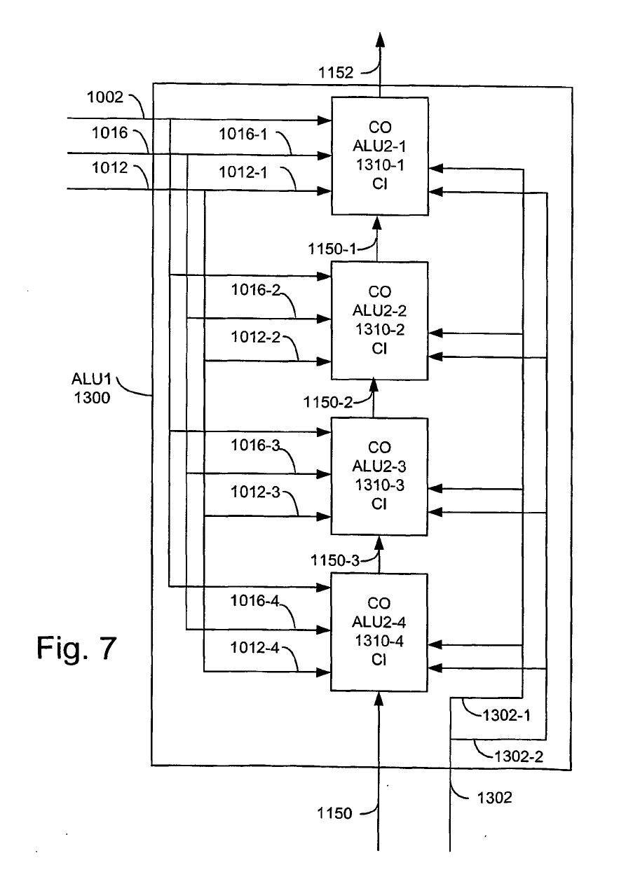

FIG. 7 shows a detail diagram of an ALU circuit 1300 in terms of four interconnected instances of a second ALU circuit 1310 supporting carry propagation controlled by partitioning wire bundle 1002.

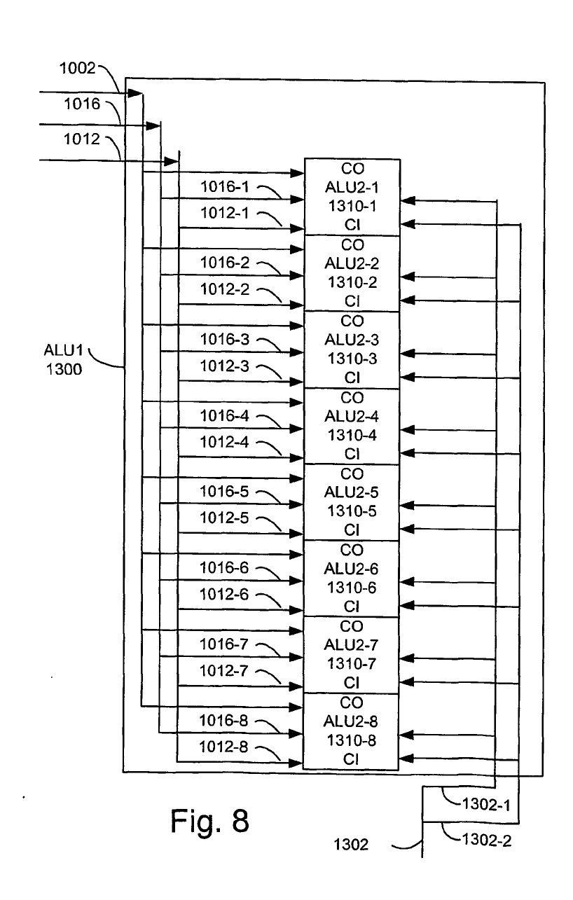

FIG. 8 shows a detail diagram of first ALU circuit 1300 in terms of eight interconnected instances of a second ALU circuit 1310 supporting carry propagation controlled by partitioning wire bundle 1002.

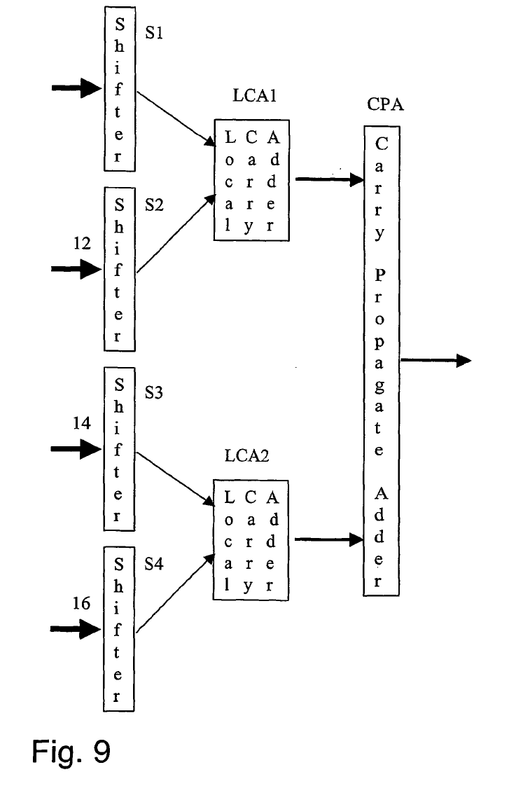

In FIGS. 8 and 9, each ALU circuit 1310 may support a consistent datapath bit width. Each ALU circuit 1310 may further support a constant datapath bit width. The constant datapath bit width may be at least one of 3, 4, and 5.

In FIGS. 8 and 9, ALU circuit 1300 may contain instances of ALU circuit 1310 supporting carry propagation controlled by partitioning wire bundle 1002. The number of instances of ALU circuit 1310 is a power of two not necessarily shown in these Figures. The number of instances of ALU circuit 1310 may not be a power of two. The number of instances of ALU circuit 1310 may be 12.

The constant bit width of ALU circuit 1310 may be 4 and the number of instances of ALU circuit 1310 belongs to a collection comprising 8, 12, 16, 24, 32, 48 and 64.

The constant bit width of ALU circuit 1310 is 3 and the number of instances of ALU circuit 1310 belongs to a collection comprising 12, 16, 24, 32, 48 and 64.

FIG. 9 depicts an arithmetic logic unit 1310 with multiple add-inputs presented to shifters and then added to generate an add-result.

Each shifter (S1, S2, S2, and S4)is controlled by add-instruction-components belonging to a collection comprising at least values representing same-sign, reverse-sign, do-not-use, shift-up and shift-down. The effects of these values acting on the add-input are as follows:

The add-input acted upon by the corresponding add-inst-component having same-sign generates the add-input.

The add-input acted upon by the corresponding add-inst-component having reverse-sign generates the negative of the add-input.

The add-input acted upon by the corresponding add-inst-component having do-not-use generates a zero.

The add-input acted upon by the corresponding add-inst-component having shift-up generates a positive power of two times the add-input.

The add-input acted upon by the corresponding add-inst-component having shift-down generates a negative power of two times the add-input.

The shift-instruction collection may further include shift-up-by-m and shift-down-by-m, where m is at least two.

Partitioning wire bundle 1002 is used to control carry propagation and shift bit propagation, but are not shown in this Figure to simplify the discussion. The omission of partitioning wire bundle 1002 is not meant to limit nor require its presence for all embodiments of the invention.

Note that the logarithm of 0 will be negative-infinity, and that the square and square root of 0 are each 0. To preserve these facts in the logarithmic domain, shifting negative-infinity should produce negative infinity.

The add-inst controls for each shifter S1-S4 may further include shift-up-2 and shift-down-2, supporting shifting by 2 bits, as well as shift-up-3 and shift-down-3 supporting shifting by 3 bits.

Certain preferred embodiments of the invention employ a subset of all these add-inst controls including same-sign, reverse-sign, do-not-use, shift-up, shift-down, shift-up-2, shift-up-3, which may be coded as 2 bits designating same-sign, reverse-sign, do-not-use, shift-down; and 2 additional bits coding pass-through, shift-up, and shift-up-2.

Note that as shown hereafter, when do-not-use is asserted, it does not matter what the other two bit field contains. In general, when do-not-use is asserted, the contents of the other two bit field will be chosen to optimize at least one system characteristic, such as testability and/or logic complexity and/or signal propagation through the circuit, also known as the circuit's critical path delay.

The add-inst control signals may originate from the datapath instruction being presented for execution, or may alternatively be generated based upon part of a numeric data to perform a limited range of multiplications. Consider the following table

| Multiplier | Add-inst-1 | Add-inst-2 |
|---|---|---|
| 000 => 0 | do-not-use | do-not-use |
| 001 => 1 | same-sign, pass-through | do-not-use |
| 010 => 2 | do-not-use | same-sign, shift-up-1 |
| 011 => 3 = 2 + 1 | same-sign, pass-through | same-sign, shift-up-1 |
| 100 => 4 | same-sign, shift-up-2 | do-not-use |
| 101 => 5 = 4 + 1 | same-sign, shift-up-2 | same-sign, pass-through |
| 110 => 6 = 4 + 2 | same-sign, shift-up-2 | same-sign, shift-up-1 |
| 111 => 7 = 8 − 1 | reverse-sign, pass-through | same-sign shift-up-3 |

Table One: a three bit multiplication based upon controlling a pair of shifter inputs. Note that this further supports the circuitry shown in FIG. 9 as supporting the multiplication of 6 bits of an operand acting upon a second number, which may be further provided by a local memory. Using this circuitry in such a fashion provides an interpolation capability supporting successive approximations, which may involve linear, multi-linear and through the feedback-cascading of partial results based upon this circuit, some forms of non-linear approximations to various non-linear functions including but not limited to various exponential functions, logarithms, trigonometric functions, among others.

An alternative approach to approximation interprets a three bit number as a signed number, leading to the following table:

| Multiplier | Add-inst-1 | Add-inst-2 |
|---|---|---|
| 000 => 0 | do-not-use | do-not-use |
| 001 => 1 | same-sign, pass-through | do-not-use |
| 010 => 2 | same-sign, pass-through | same-sign, |
| | | pass-through |
| 011 => 3 = 2 + 1 | same-sign, pass-through | same-sign, shift-up-1 |
| 100 => −4 | reverse-sign, shift-up-1 | reverse-sign, shift-up-1 |
| 101 => −3 = −4 + 1 | reverse-sign, pass-through | reverse-sign, shift-up-1 |
| 110 => −2 | reverse-sign, pass-through | reverse-sign, |
| | | pass-through |
| 111 => −1 | reverse-sign, pass-through | do-no-use |

Table Two: a signed three bit multiplication based upon controlling a pair of shifter inputs.

Note that these two tables may be concurrently employed in certain situations where a signed 6 bit numeric multiplication is desired. The most significant 3 bits affect multiplication as shown in Table Two. When the sign of the 6 bit quantity is negative, the least significant 3 bits may affect the multiplication as shown in Table One, with every instance of reverse-sign changed to same-sign, and every instance of same-sign changed to reverse-sign. When the sign of the 6 bit quantity is positive, Table One may be used as shown.

These tables and discussions have been provided by way of example and are not meant to limit the scope of the claims. As one of skill in the art will readily recognize, there are many alternative notations for the various operations presented herein which are essentially equivalent to the examples presented herein.

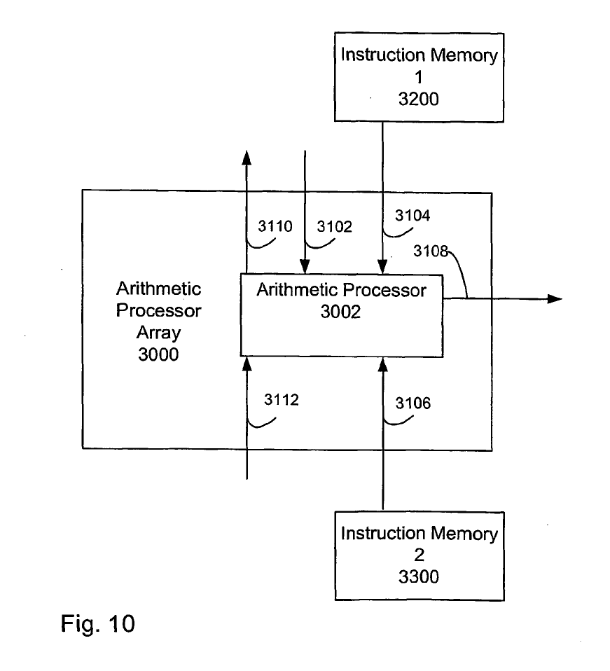

FIG. 10 shows Arithmetic Process Array 3000 comprising at least one Arithmetic Processor 3002, each coupled with 3104 Instruction Memory 3200 and with 3106 Instruction Memory 3300, in accordance with certain embodiments of the invention.

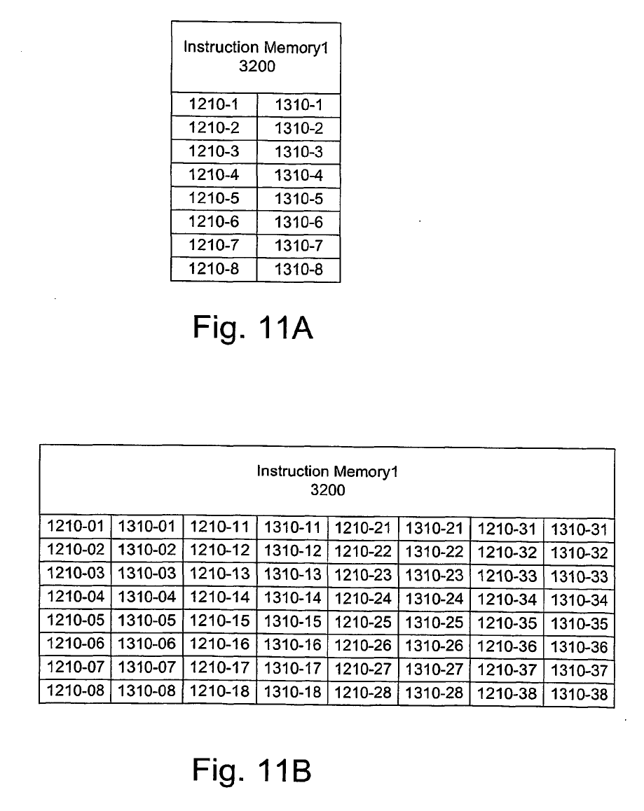

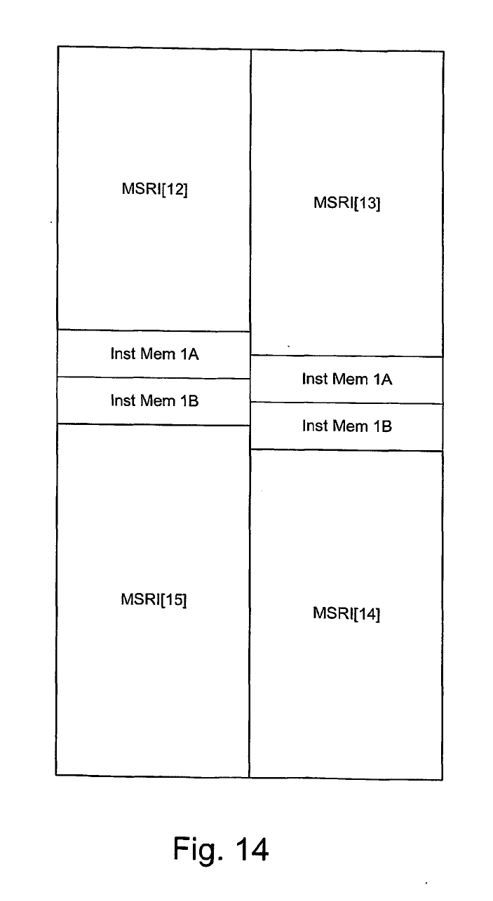

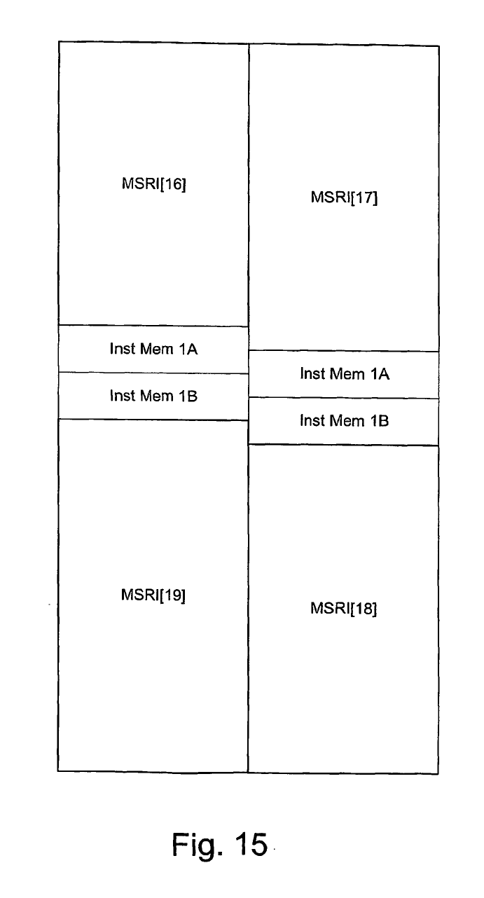

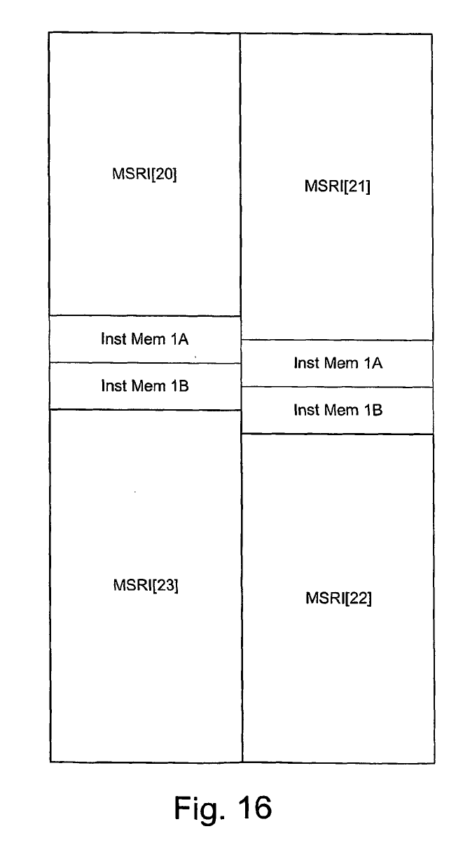

In certain embodiments of the invention, only one instruction memory 3200 is coupled to Arithmetic Processor Array 3000, feeding one instruction to each Arithmetic Processor 3002. FIGS. 11A to 16 refer to such embodiments of the invention. Note that these embodiments of the invention do not require the partitioning wire bundle 3102, nor the partitioning wire bundle 1002.

FIG. 11A show a single column of coupled first memories 1210-i and ALU2 1310-i, where i=1 to 8. Note that in other embodiments of the invention, i could range over a different range. Note also that in other embodiments of the invention, each ALU2 1310 unit could be coupled to the first memories 1210 as second memories. Note that these circuits would be simpler, thus take up less circuit area and consume less power, but could not reconfigure the datapath bit-width, which would be determined by the number of cells (the range of i) and the datapath width of the horizontal strips. The two dimensional strips containing memories 1210-i and ALU2 cells 1310-i are further integrated as an MSRI[k] cell array where i ranges from 1 to k.

FIG. 11B show four columns of coupled first memories 1210-i and ALU2 1310-i, where i=1 to 8. Note that in other embodiments of the invention, i could range over a different range. Note also that in other embodiments of the invention, each ALU2 1310 unit could be coupled to the first memories 1210 as second memories. Note that these circuits would be simpler, thus take up less circuit area and consume less power, but could not reconfigure the datapath bit-width, which would be determined by the number of cells (the range of i) and the datapath width of the horizontal strips. The two dimensional strips containing memories 1210-i and ALU2 cells 1310-i are further integrated as an MSRI[k] cell array where i ranges from 1 to k.

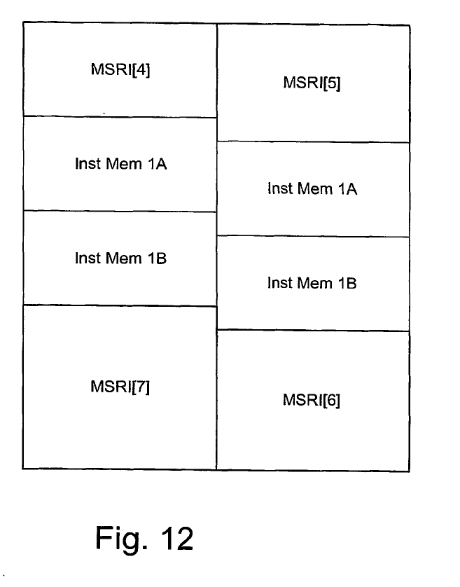

FIGS. 12 to 16 show a configuration of instruction memories and MSRI[k] sufficient to perform a large number of realtime filtering and more sophisticated tasks upon an input stream of 8 or 9 bit samples. Assume the horizontal datapath width of the ALU2 and memories in each MSRI is at least 3, preferably 4, bits. When the horizontal datapath width of the ALU2 and memories in each MSRI is 4 bits, 10 bit samples could also be accepted.

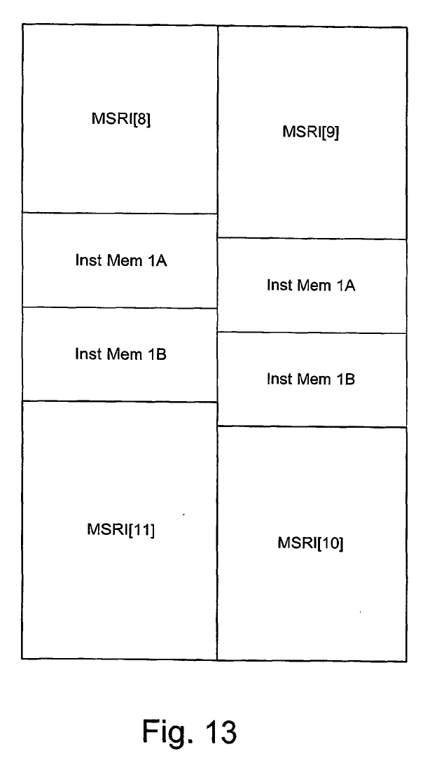

The data stream enters MSRI[4] in FIG. 12 flowing to MSRI[5], then MSRI[6], MSRI[7], then MSRI[8] of FIG. 13 eventually leaving MSRI[231 having performed as a 12 pass arithmetic stream processor. If each MSRI component performs a radix 4 FFT, then the system as a whole performs a 1K FFT by the time the data leaves MSRI[21], and a 4K FFT upon leaving MSRI[23]. The increase in depth of the MSRI's is to consistently extend the precision of the calculations to account for the accumulation of rounding errors.

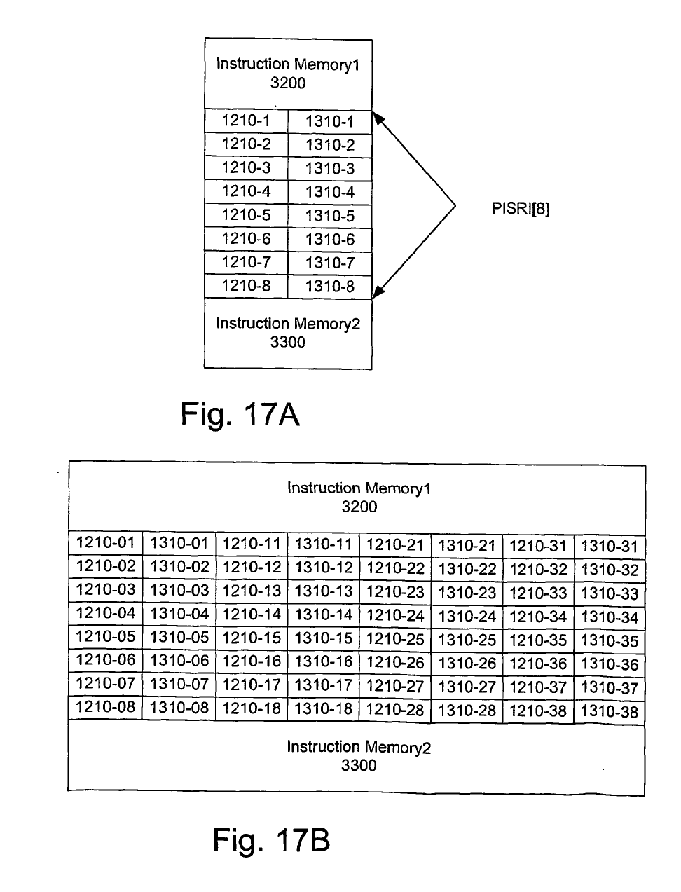

In certain other embodiments of the invention, two instruction memories 3200 and 3300 are coupled to Arithmetic Processor Array 3000, feeding two instructions to each Arithmetic Processor 3002, the selection of which instruction is executed determined by the partitioning wire bundle 3102, which in turn drives the partitioning wire bundle 1002. FIGS. 17A to 20 refer to such embodiments of the invention.

FIG. 17A show a single column of coupled first memories 1210-i and ALU2 1310-i, where i=1 to 8, with two instructions memories 3200 and 3300 providing two instructions transmitted to each. Note that in other embodiments of the invention, i could range over a different range. Note also that in other embodiments of the invention, each ALU2 1310 unit could be coupled to the firstmemories 1210 as second memories. Note that these circuits would be simpler, thus take up less circuit area and consume less power, but could not reconfigure the datapath bit-width, which would be determined by the number of cells (the range of i) and the datapath width of the horizontal strips.

The two dimensional strips containing memories 1210-i and ALU2 cells 1310-i are further integrated as an PISRI[k] cell array where i ranges from 1 to k. This circuit and the circuit of FIG. 17B use the partitioning wire bundle 1002 to control carry propagation and determination of which of the two instructions are executed in each horizontal strip of the PISRI.

FIG. 17B show four columns of coupled first memories 1210-i and ALU2 1310-i, where i=1 to 8, with two instructions memories 3200 and 3300 providing two instructions transmitted to each. Note that in other embodiments of the invention, i could range over a different range. Note also that in other embodiments of the invention, each ALU2 1310 unit could be coupled to the first memories 1210 as second memories. Note that these circuits would be simpler, thus take up less circuit area and consume less power, but could not reconfigure the datapath bit-width, which would be determined by the number of cells (the range of i) and the datapath width of the horizontal strips. The two dimensional strips containing memories 1210-i and ALU2 cells 1310-i are further integrated as an PISRI[K] cell array where i ranges from 1 to k.

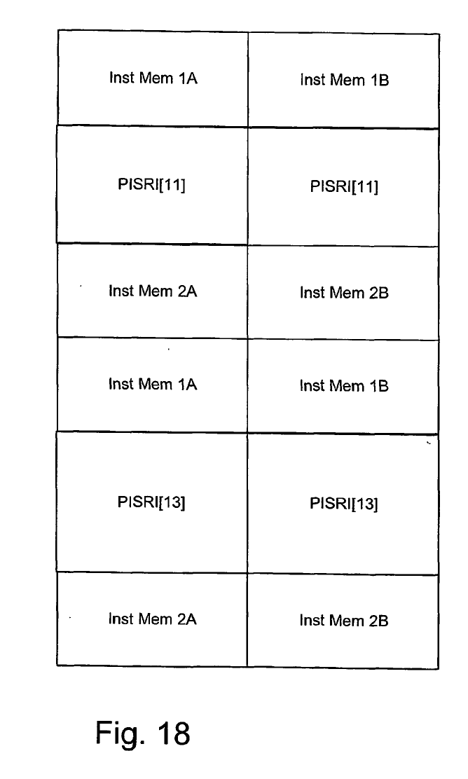

FIGS. 18 to 20 show various configurations of PISRI's and their neighboring instruction memories. In FIG. 18, PSRI[11] can be configured to act as an MSRI[4] and MSRI[7], or as an MSRI[5] and MSRI[6]. The net effect can then be the processing flow of MSRI[4]==>MSRI[5]==>MSRI[6]==>MSRI[7]. Similarly, the PSRI[19]'s can be configured as ==>MSRI[9]==>MSRI[10]==>MSRI[11].

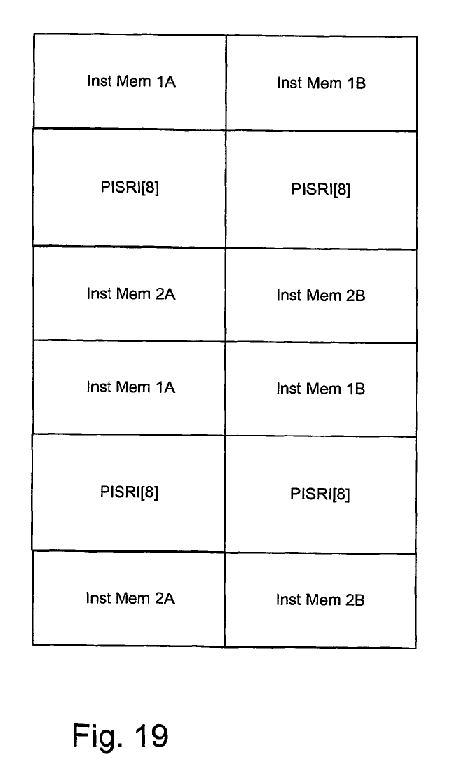

FIG. 19 shows a configuration of same size PISRI[8]'s which can be support dataflows as discussed above, and which provide a 32 bit data interface to standard computer memories when the datapath bit width of the ALU2 1310 and memories 1210 cells is 4 bits. Note that the partitioning wire bundle would also have an effect on the operation of the data interface to standard memories to preserve data alignments or to partition the external data memory into two address ranges, one for each partition.

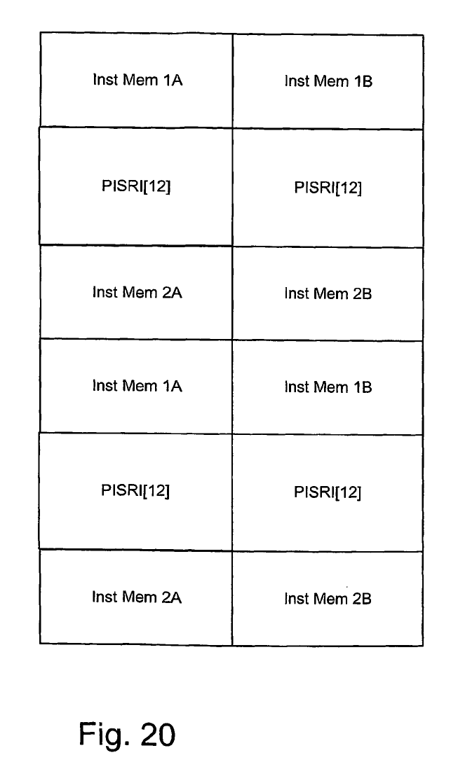

FIG. 20 shows a configuration of same size PISRI[12]'s which can be support dataflows as discussed above, and which provide a 36 bit data interface to standard computer memories when the datapath bit width of the ALU2 1310 and memories 1210 cells is 3 bits. Note that the partitioning wire bundle would also have an effect on the operation of the data interface to standard memories to preserve data alignments or to partition the external data memory into two address ranges, one for each partition.

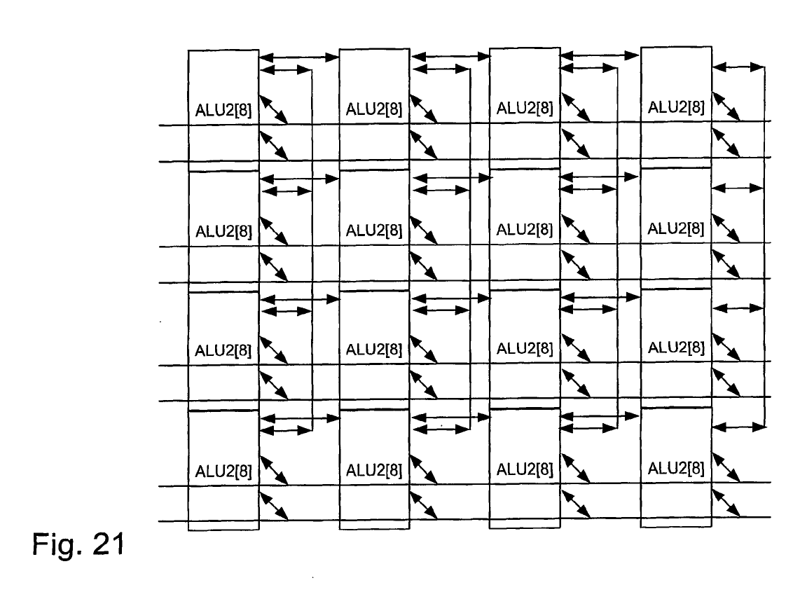

FIG. 21 shows a high level data flow diagram of a two dimensional array blocks 1300 of ALU2 circuits 1310 and connecting datapaths between them by which data may be transported. Data flow as depicted in FIG. 21 supports both nearest neighbor and global communication of array blocks in each of the two dimensions of the array.

Note that the vertical communications lines shown in FIG. 21 may be used to transfer data via an external data memory interface which is not shown. Such an external data memory interface may receive addressing signal either from datapath element(s), and/or from one or more instruction processors.

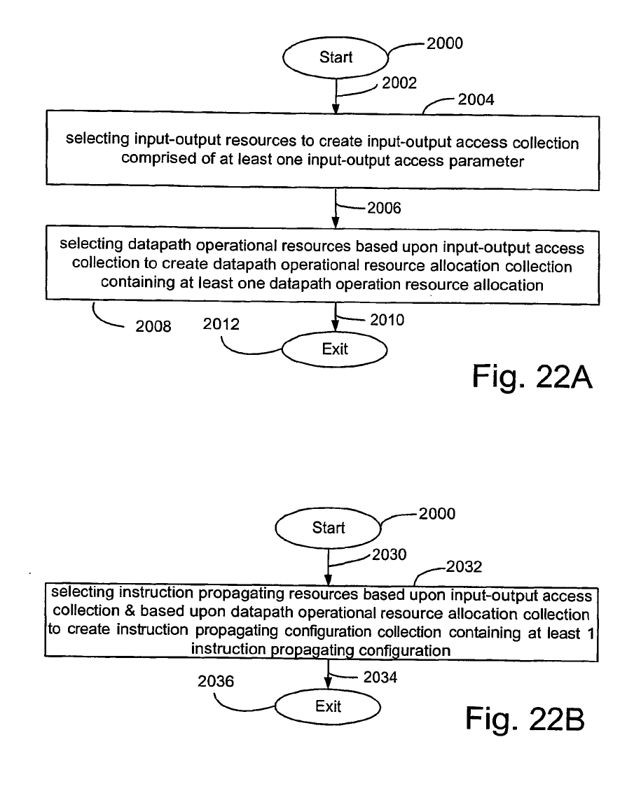

FIG. 22A depicts a flowchart performing a method of using an array of computational resources containing at least one input-output resource, at least one datapath operational resource in accordance with certain embodiments of the invention.

User operation 2000 starts the usage of this flowchart. Arrow 2002 directs the usage flow from user operation 2000 to user operation 2004. User operation 2004 performs selecting the input-output resources to create an input-output access collection comprised of at least one input-output access parameter Arrow 2006 directs usage from user operation 2004 to user operation 2008. User operation 2008 performs selecting the datapath operational resources based upon the input-output access collection to create a datapath operational resource allocation collection containing at least one datapath operation resource allocation. Arrow 2010 directs usage from user operation 2008 to user operation 2012. User operation 2012 terminates the usage of this flowchart.

Note that in other embodiments of the invention, the flowchart of FIG. 22A may be used to depict a method of operating an array of computational resources containing at least one input-output resource, at least one datapath operational resource. The array of computational resources may be implemented using one or more programmable logic devices, which may include or more programmable logic arrays and/or one or more Filed Programmable Gate Arrays (FPGAs).

Certain further embodiments of the invention include the array of computation resources further containing at least one instruction propagating resource.

FIG. 22B depicts a detail flowchart of user operation 2000 of FIG. 22A further performing selecting the instruction propagating resources based upon the input-output access collection and based upon the datapath operational resource allocation collection to create an instruction propagating configuration collection containing at least one instruction propagating configuration, in accordance with certain embodiments of the invention.

Arrow 2030 directs the usage flow from starting user operation 2000 to user operation 2032. User operation 2032 performs selecting the instruction propagating resources based upon the input-output access collection and based upon the datapath operational resource allocation collection to create an instruction propagating configuration collection containing at least one instruction propagating configuration. Arrow 2034 directs usage from user operation 2032 to user operation 2036. User operation 2036 terminates the usage of this flowchart.

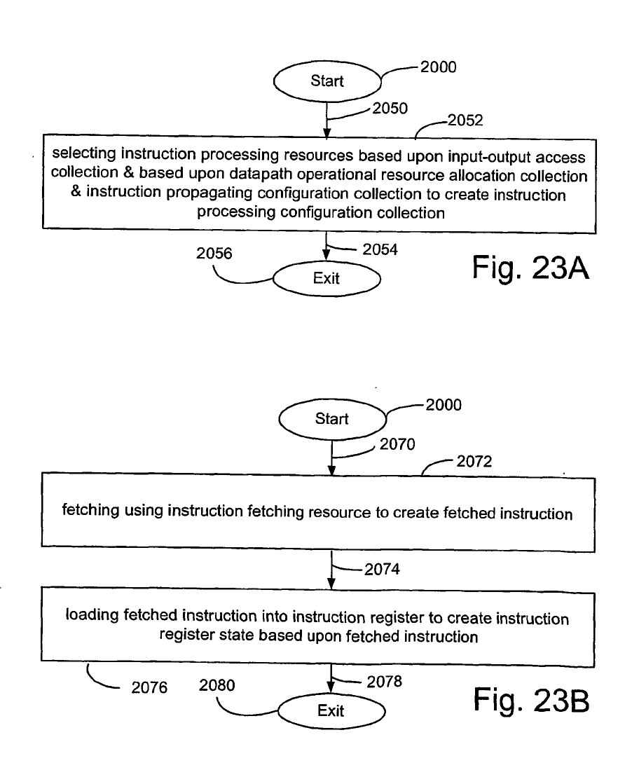

FIG. 23A depicts a detail flowchart of user operation 2000 of FIG. 22A performing selecting the instruction processing resources based upon the input-output access collection, the datapath operational resource allocation collection, and the instruction propagating configuration collection to create an instruction processing configuration collection containing at least one instruction processing configuration in accordance with certain embodiments of the invention.

Arrow 2050 directs the usage flow from starting user operation 2000 to user operation 2052. User operation 2052 performs selecting the instruction processing resources based upon the input-output access collection and based upon the datapath operational resource allocation collection and based upon the instruction propagating configuration collection to create an instruction processing configuration collection containing at least one instruction processing configuration. Arrow 2054 directs usage from user operation 2052 to user operation 2056. User operation 2056 terminates the usage of this flowchart.

Certain further embodiments of the invention include the array of computation resources further containing at least one instruction fetching resource and the instruction processing resources containing at least one instruction register.

FIG. 23B depicts a detail flowchart of user operation 2000 of FIG. 22A further performing the method of using/operating the array of computational resources in accordance with certain embodiments of the invention.

Arrow 2070 directs the usage flow from starting user operation 2000 to user operation 2072. User operation 2072 performs fetching using the instruction fetching resource to create a fetched instruction. Arrow 2074 directs usage from user operation 2072 to user operation 2076. User operation 2076 performs loading the fetched instruction into the instruction register to create an instruction register state based upon the fetched instruction. Arrow 2078 directs usage from user operation 2076 to user operation 2080. User operation 2080 terminates the usage of this flowchart.

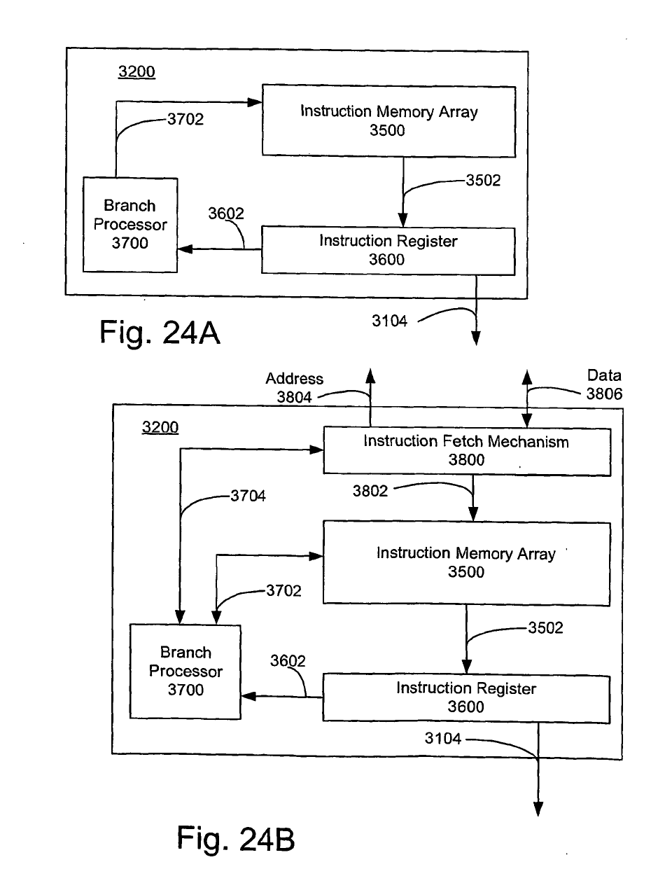

FIG. 24A shows a detail block diagram of an instruction memory 3200 comprised of instruction register 3600, branch processor 3700 and instruction memory array 3500, in accordance with certain embodiments of the invention.

Branch processor 3700 in certain further embodiments of the invention includes a branch return stack. In certain further embodiments of the invention, the branch return stack can be unloaded and reloaded via arrow 3702.

FIG. 24B shows a detail block diagram of an instruction memory 3200 extending the block diagram of FIG. 24A further comprised of instruction fetch mechanism 3800, in accordance with certain embodiments of the invention.

Branch processor 3700 in certain further embodiments of the invention includes a branch return stack. In certain further embodiments of the invention, the branch return stack can be unloaded and reloaded via arrow 3702.

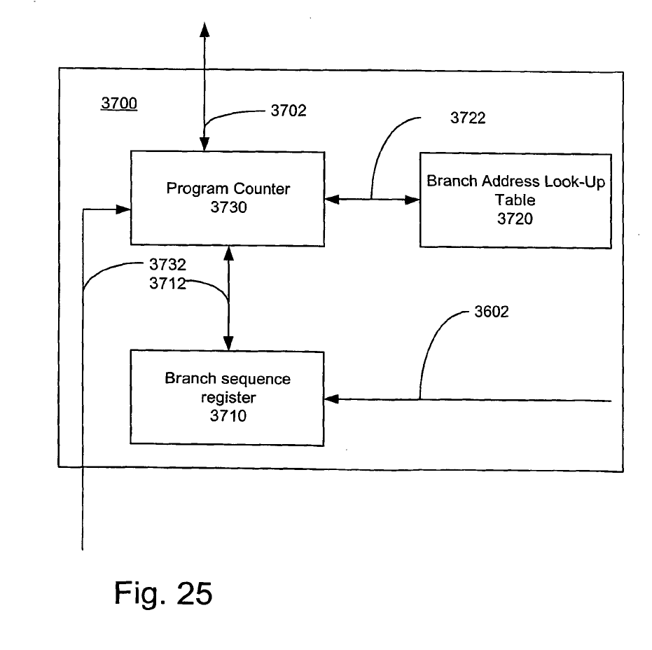

FIG. 25 shows a detail block diagram of an branch processor 3700 comprised of branch sequence register 3710, program counter 3730 and branch address look-up table 3720, in accordance with certain embodiments of the invention.

Branch processor 3700 in certain further embodiments of the invention includes a branch return stack. In certain further embodiments of the invention, the branch return stack can be unloaded and reloaded via arrow 3702.

Branch Address Loop-Up Table 3720 may include an interpreter address look-up table supporting an interpretive language, in certain further embodiments of the invention. Such interpretive languages may include but are not limited to JAVA, FORTH and Smalltalk.

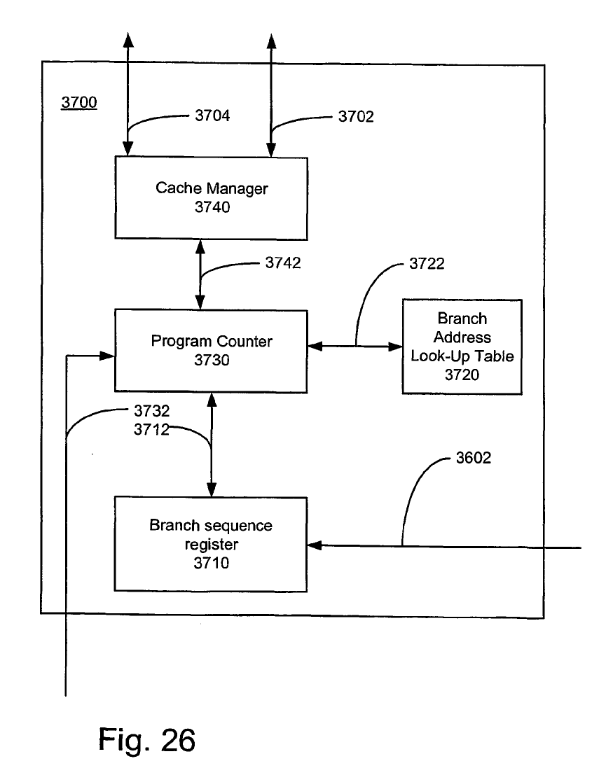

FIG. 26 shows a detail block diagram of an branch processor 3700 extending the block diagram of FIG. 25 further comprised of cache manager 3740, in accordance with certain embodiments of the invention.

Branch processor 3700 in certain further embodiments of the invention includes a branch return stack. In certain further embodiments of the invention, the branch return stack can be unloaded and reloaded via arrow 3702.

Branch Address Loop-Up Table 3720 may include an interpreter address look-up table supporting an interpretive language, in certain further embodiments of the invention. Such interpretive languages may include but are not limited to JAVA, FORTH and Smalltalk.

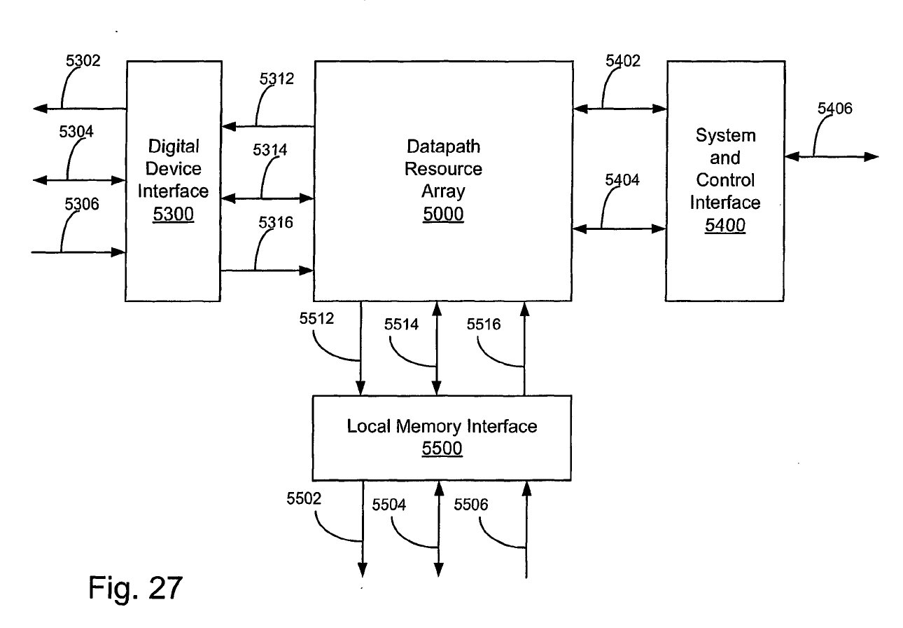

FIG. 27 depicts a high level system block diagram of a DSP Resource Circuit in accordance with certain embodiments of the invention.

The DSP Resource Circuit is comprised a Datapath Resource Array 5000. The Datapath Resource Array 5000 is coupled to at least one of the following: the Digital Device Interface 5300 and the System and Control Interface 5400.

When applicable, Datapath Resource Array 5000 is coupled by at least one of 5312,5314 and/or 5316 with Digital Device Interface 5300.

In certain applications, coupling 5312 communicates memory access request information including but not limited to address information, and where appropriate, memory access length. Coupling 5314 preferably communicates data received from the Datapath Resource Array 5000 for storage elsewhere, as well as data being sent to the Datapath Resource Array 5000. Coupling 5316 may be used to convey status information, which may include but is not limited to at least one of the following: memory latency-wait states, which may be current or projected, as well as error status information including but not limited to checksum errors and other error detection related information. Note that the couplings 5302, 5304, and 5306 preferably respectively relate to the external communications associated with couplings 5312, 5314, and 5316 in such applications.

In other applications, one input-output processor may strictly receive data via coupling 5316 which is generated based upon an external input stream via coupling 5306. Additionally, an input-output processor may strictly output data via coupling 5312 which is used to generate an external data stream presented via coupling 5302.

In certain applications, each of these coupling may be preferably split into two such couplings, each under the control of a separate input-output processor.

The Datapath Resource Array 5000 may also be coupled to a Local Memory Interface 5500. When applicable, Datapath Resource Array 5000 is coupled by at least one of 5512,5514 and/or 5516 to Local Memory Interface 5500. Preferably, coupling 5512 communicates memory access request information including but not limited to address information, and where appropriate, memory access length. Coupling 5514 preferably communicates data received from the Datapath Resource Array 5000 for storage elsewhere, as well as data being sent to the Datapath Resource

Array 5000. Coupling 5516 may be used to convey status information, which may include but is not limited to at least one of the following: memory latency-wait states, which may be current or projected, as well as error status information including but not limited to checksum errors and other error detection related information. Note that preferably, couplings 5502, 5504, and 5506 respectively relate to the external communications associated with couplings 5512, 5514, and 5516.

When applicable, Datapath Resource Array 5000 is coupled by at least one of 5402 and/or 5404 to System and Control Interface 5400.

Each or either of couplings 5402 and 5404 may be comprised of a collection of couplings such as discussed above in FIG. 27 with unidirectional couplings and possibly strictly bi-directional couplings.

In certain applications, coupling 5402 may preferably convey system control and status information related via 5406 with an external system environment.

In certain applications, coupling 5404 may convey data communicated via 5406 with the external system environment. Such data may be provided during system initialization time for conveyance not only into internal memory within the Datapath Resource Array 5000. Coupling 5404 may also be used during system initialization for further data conveyance through Datapath Resource Array 5000 to Local Memory Interface 5500 for storage in local memory. Coupling 5404 may also be used during system initialization for further data conveyance through Datapath Resource Array 5000 to Digital Device Interface 5300 for use elsewhere.

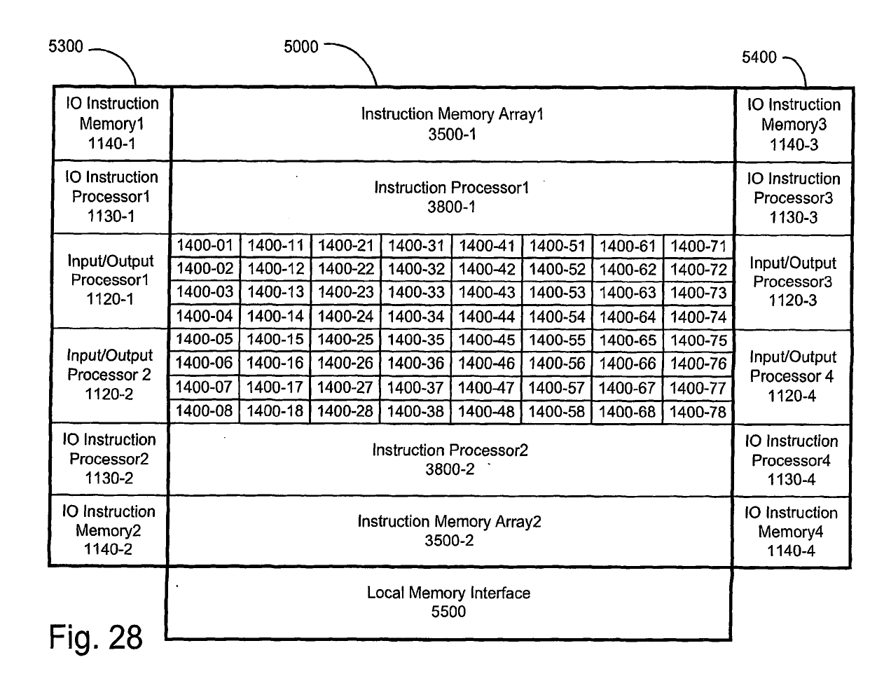

FIG. 28 depicts a simplified floor plan of a layout of the DSP Resource Circuit of FIG. 27.

Datapath Resource Array 5000 is comprised of at least one instruction processor 3800 and an array of DSP resources 1400. By way of example, FIG. 28 depicts an array of 8 rows and 8 columns of DSP resource 1400 instances. Instruction processor 3800 may be closely coupled with an instruction memory array 3500.

In certain applications, Datapath Resource Array 5000 is preferably comprised of two instruction processors 3800-1 and 3800-2. At this level of abstraction the partition control wire bundle is not visible. However, it is assumed to support partitioning the array of DSP resources into two horizontal regions. By way of example, the top three rows of the array of DSP resources may be partitioned to act based upon an instruction state communicated from instruction processor 1 3800-1. The remaining bottom 5 rows of the array of DSP resources may be partitioned to act based upon an instruction state communicated from instruction processor 2 3800-2.

In certain applications a further partitioning of instruction processing resources may be preferred. An instruction processor 3800 may be partitioned into two instruction processing streams, each with independent branch mechanism. The first instruction processing stream may be partitioned to control the instruction state asserted for the three left-most columns of the array of DSP resources. The second instruction processing stream would control the remaining 5 columns of the array of DSP resources. Note that in certain applications, partitioning may support more than two instruction processing streams being sent from an instruction processor. For simplicity of discussion, no more than two instruction streams will be discussed hereafter. This is not meant to limit the scope of the claims.

By way of example, the applications and configurations of FIGS. 12 to 20 may be implemented by circuitry illustrated in FIG. 28.

Digital Device Interface 5300 is comprised of at least one at least one input-output instruction processor 1130-1 controlling an input-output processor 1120-1.

Digital Device Interface 5300 may be further comprised of a second input-output instruction processor 1130-2 controlling input-output processor 1120-2.

In certain applications, at least one input-output instruction processor 1130 may be coupled to an input-output instruction memory 1140.

Input-output processors preferably possess couplings to all the rows of their associated array of DSP resources 1400. Input-output processors preferably configure communication to the array of DSP resources based upon the partition state information which configures the rows of the array of DSP resources to communicate together. By way of example, the first input-output processor 1120-1 may communicate with the top three rows of the array of DSP resources, when they are so partitioned. The second input-output processor 1120-2 may then preferably communicate with the remaining 5 bottom rows.

Note that the rows of DSP resources may be partitioned into more than two communicating components. Similarly, the Digital Device Interface 5300 may comprise more than two input-output instruction processors controlling more than two input-output processors.

Each input-output processor may include at least one of the following: a data memory, ALU, and specialized logical functions such as bit packing-unpacking circuits. Note that the circuitry of FIGS. 27 and 28 may further reside in a package where at least one of the interfaces couples to analog circuitry including but not limited to at least one of the following: A/D converters, D/A converters, frequency synthesizers, threshold detectors, and amplifiers.

Note that implementations of multiple instances of the circuitry of FIG. 28 may include situations where one input-output processor of a first instance may not couple to elements of another array of DSP resources 1400 within another instance.

System and Control Interface 5400 may be comprised of at least one input-output processor 1120-3 controlled by input-output instruction processor 1130-3. The preceding discussion regarding the Digital Device Interface is applicable to System and Control Interface 5400, and will not be repeated for reasons of brevity. However, this is not meant limit the scope of the claims.

A common branching mechanism is preferably employed through the instruction processors discussed in FIG. 28. This branching mechanism can be embodied to support caching and accessing of memory through a local memory interface 5500, or may be embodied without support of external memory.

The overall instruction processing principles embodied in this invention include the following design/architectural goals: Input-output and datapath configurations dominate the embodied architectures, not the other way around. The hardware supports software debugging and test. The embodied architectures can support multiple systems levels of instruction fetching. They can support both SIMD and MIMD, as well as SISD and MISD processing applications. Implementations support separate references to data and instructions.

There are several consequences to separate data and instruction references. The runtime environments of procedural languages such C, C++, PASCAL, FORTRAN and JAVA. By employing an invariant instruction set across a variety of datapath size ranges, a single program can handle a wide range of input data sizes with the arithmetical precision preserved by construction. Another consequence is the requirement of parameter passing to functions and subroutines by reference only.

Consider for a moment the runtime stack frame requirements of the C programming language. C's runtime stack frame contains the following components: Branch related pointers, loop counters, data address references and data values, all of which may have differing data widths. By partitioning the stack frame into multiple stack frame into separate stack frames to handle differing data widths, the communication and manipulation of data to “fit” onto a single stack frame, or “fit” back into the processing element where it is needed is minimized.

There are further architectural preferences which ease the task of compilation of procedural language programs as well as improve the reliability of these translations.

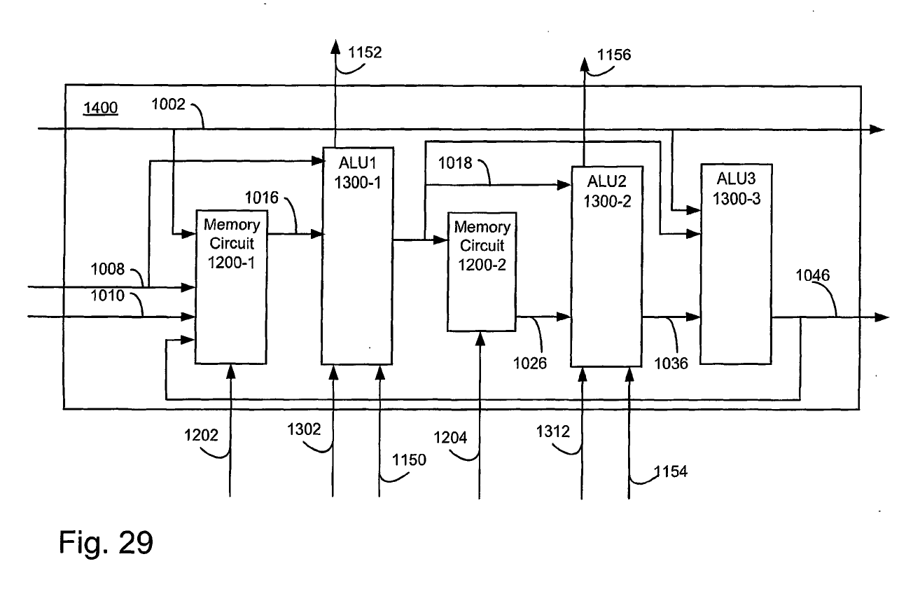

FIG. 29 depicts a preferred version of ALU 1400, as used in FIG. 28 and earlier Figures supporting configurations of its internal memories and system input 1002 emulating a multiplier-accumulator with local register bank.

Arithmetic processor 1400 preferably contains 3 ALUs, 1300-1, 1300-2 and 1300-3, with two memories 1200-1 and 1200-2 respectively feeding 1016 and 1018 the first two ALUs 1300-1 and 1300-2. The third ALU 1300-3 is feed by at least ALU 1300-2 and wire bundle 1002.

System input 1002 preferably contains representations of normal numbers and numbers in a logarithmic domain. The logarithmic domain will be discussed in detail shortly. The normal number representation be stored in memory 1200-1. ALU 1300-2 may further be implemented in a fashion as shown in FIG. 9, with shift controls being provided from part of the numeric signaling received from wire bundle 1018, as well as at least part of the addressing being provided by parts of the numeric signals received from wire bundle 1018. The results of the two ALU 1300-1 and 1300-2 operations are sent 1018 and 1036 to ALU 1300-3, where the results are combined to form an efficient and very accurate approximation of a sum of numerical products.

As mentioned earlier, there are some fundamental problems with multipliers. Most importantly, they tend to grow with the product of the input precision. While this may be somewhat constrained by output precision requirements, it remains a fundamental problem. An approach that solve this problem will now be described.

Consider the action of representing each member of a number collection by an integer part and a special part, where the special part contains exactly one member of a first special value collection comprising negative-infinity and not-negative-infinity.

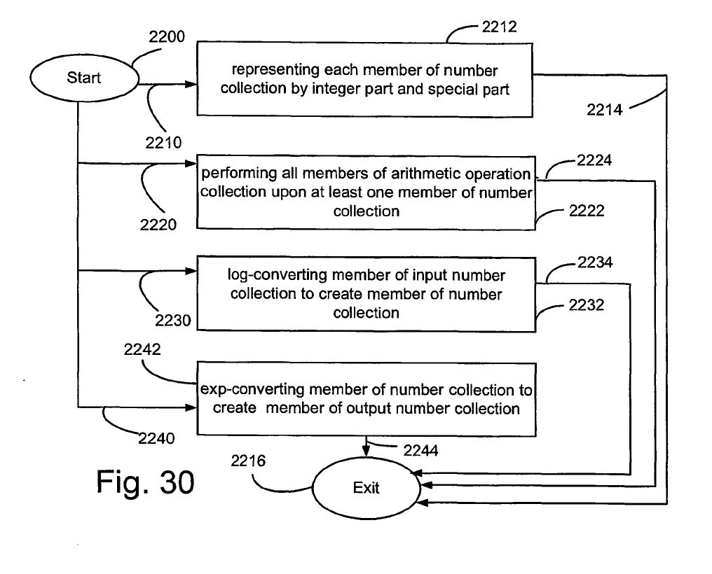

FIG. 30 depicts a flowchart of a method of processing numeric data, which may be variously embodied.

Arrow 2210 directs the flow of execution from starting operation 2200 to operation 2212. Operation 2212 performs representing each member of a number collection by an integerpart and a special part. Arrow 2214 directs execution from operation 2212 to operation 226. Operation 226 terminates the operations of this flowchart.

Arrow 2220 directs the flow of execution from starting operation 2200 to operation 2222. Operation 2222 performs performing at least one member of the arithmetic operation collection upon at least one of the members of the number collection. Arrow 2224 directs execution from operation 2222 to operation 226. Operation 226 terminates the operations of this flowchart.

Certain embodiments of the invention may perform all members of the arithmetic operation collection upon the relevant member of the number collection.

Certain embodiments of the invention may further include one or both of the following operational steps.

Arrow 2230 directs the flow of execution from starting operation 2200 to operation 2232. Operation 2232 performs log-converting a member of an input number collection to create a member of the number collection. Arrow 2234 directs execution from operation 2232 to operation 226. Operation 226 terminates the operations of this flowchart.

Arrow 2240 directs the flow of execution from starting operation 2200 to operation 2242. Operation 2242 performs exp-converting a member of the number collection to create a member of an output number collection. Arrow 2244 directs execution from operation 2242 to operation 2216. Operation 2216 terminates the operations of this flowchart.

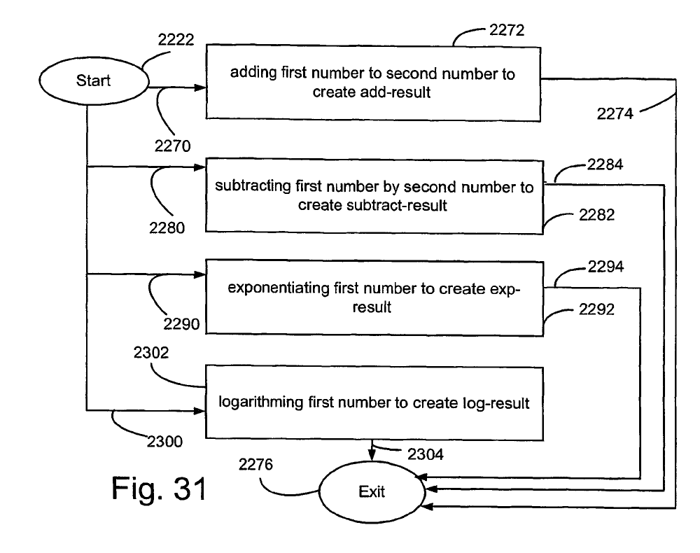

FIG. 31 depicts a detail flowchart of operation 2222 of FIG. 30 further performing the arithmetic operation collection.

Arrow 2270 directs the flow of execution from starting operation 2222 to operation 2272. Operation 2272 performs adding the first number to the second number to create an add-result. Arrow 2274 directs execution from operation 2272 to operation 2276. Operation 2276 terminates the operations of this flowchart.

Arrow 2280 directs the flow of execution from starting operation 2222 to operation 2282. Operation 2282 performs subtracting the first number by the second number to create a subtract-result. Arrow 2284 directs execution from operation 2282 to operation 2276. Operation 2276 terminates the operations of this flowchart.

Arrow 2290 directs the flow of execution from starting operation 2222 to operation 2292. Operation 2292 performs exponentiating the first number to create an exp-result. Arrow 2294 directs execution from operation 2292 to operation 2276. Operation 2276 terminates the operations of this flowchart.

Arrow 2300 directs the flow of execution from starting operation 2222 to operation 2302. Operation 2302 performs logarithming the first number to create a log-result. Arrow 2304 directs execution from operation 2302 to operation 2276. Operation 2276 terminates the operations of this flowchart.

Note that the number collection is further comprised of the add-result, the subtract-result, the exp-result and the log-result.

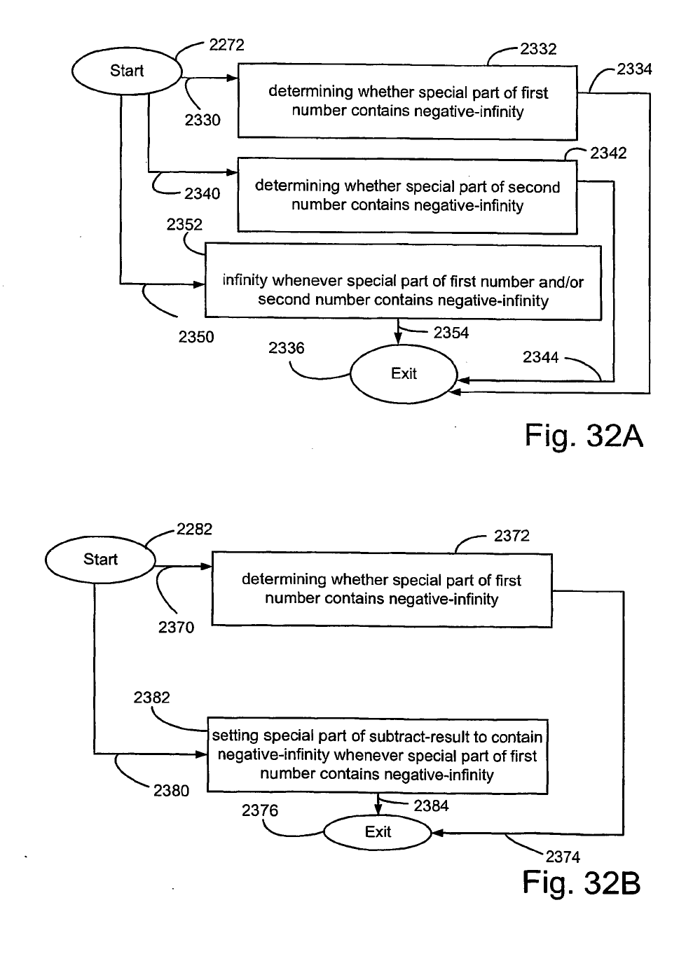

FIG. 32A depicts a detail flowchart of operation 2272 of FIG. 31 further adding.

Arrow 2330 directs the flow of execution from starting operation 2272 to operation 2332. Operation 2332 performs determining whether the special part of the first number contains the negative-infinity. Arrow 2334 directs execution from operation 2332 to operation 2336. Operation 2336 terminates the operations of this flowchart.

Arrow 2340 directs the flow of execution from starting operation 2272 to operation 2342. Operation 2342 performs determining whether the special part of the second number contains the negative-infinity. Arrow 2344 directs execution from operation 2342 to operation 2336. Operation 2336 terminates the operations of this flowchart.

Arrow 2350 directs the flow of execution from starting operation 2272 to operation 2352. Operation 2352 performs setting the special part of the add-result to contain the negative-infinity whenever the special part of at least one member of the collection the first number and the second number contains the negative-infinity. Arrow 2354 directs execution from operation 2352 to operation 2336. Operation 2336 terminates the operations of this flowchart.

FIG. 32B depicts a detail flowchart of operation 2282 of FIG. 31 further subtracting.

Arrow 2370 directs the flow of execution from starting operation 2282 to operation 2372. Operation 2372 performs determining whether the special part of the first number contains the negative-infinity. Arrow 2374 directs execution from operation 2372 to operation 2376. Operation 2376 terminates the operations of this flowchart.

Arrow 2380 directs the flow of execution from starting operation 2282 to operation 2382. Operation 2382 performs setting the special part of the subtract-result to contain the negative-infinity whenever the special part of the first number contains the negative-infinity. Arrow 2384 directs execution from operation 2382 to operation 2376. Operation 2376 terminates the operations of this flowchart.

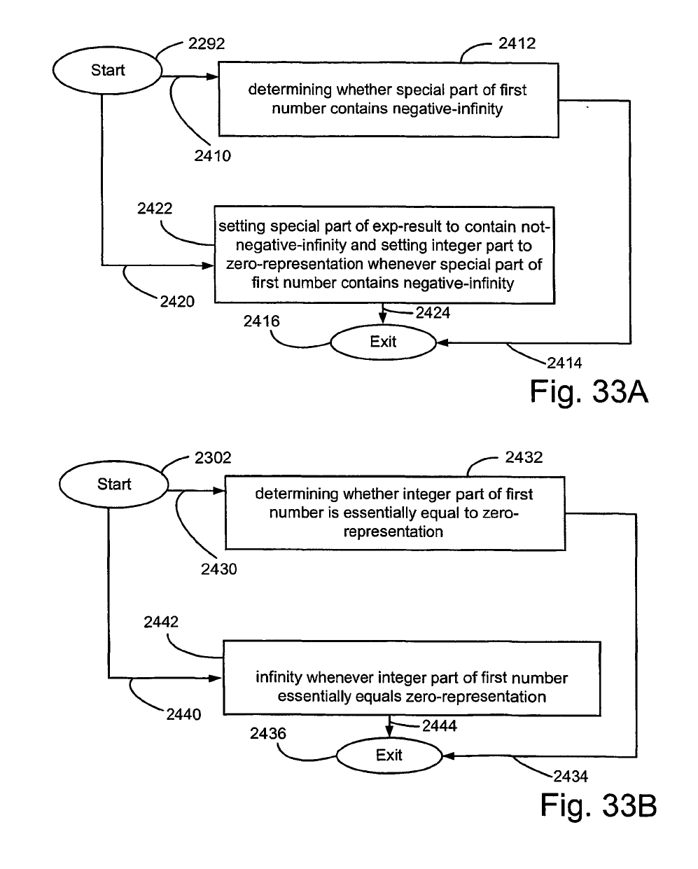

FIG. 33A depicts a detail flowchart of operation 2292 of FIG. 31 further exponentiating.

Arrow 2410 directs the flow of execution from starting operation 292 to operation 2412. Operation 2412 performs determining whether the special part of the first number contains the negative-infinity. Arrow 2414 directs execution from operation 2412 to operation 2416. Operation 2416 terminates the operations of this flowchart.

Arrow 2420 directs the flow of execution from starting operation 292 to operation 2422. Operation 2422 performs setting the special part of the exp-result to contain the not-negative-infinity and setting the integer part to a zero-representation whenever the special part of the first number contains the negative-infinity. Arrow 2424 directs execution from operation 2422 to operation 2416. Operation 2416 terminates the operations of this flowchart.

FIG. 33B depicts a detail flowchart of operation 2302 of FIG. 31 further logarithming.

Arrow 2430 directs the flow of execution from starting operation 2302 to operation 2432. Operation 2432 performs determining whether the integer part of the first number is essentially equal to the zero-representation. Arrow 2434 directs execution from operation 2432 to operation 2436. Operation 2436 terminates the operations of this flowchart.

Arrow 2440 directs the flow of execution from starting operation 2302 to operation 2442. Operation 2442 performs setting the special part of the log-result to contain the negative-infinity whenever the integer part of the first number essentially equals the zero-representation. Arrow 2444 directs execution from operation 2442 to operation 2436. Operation 2436 terminates the operations of this flowchart.

Note that the integer part of each of the number collection members may be in a non-redundant numeric notation.

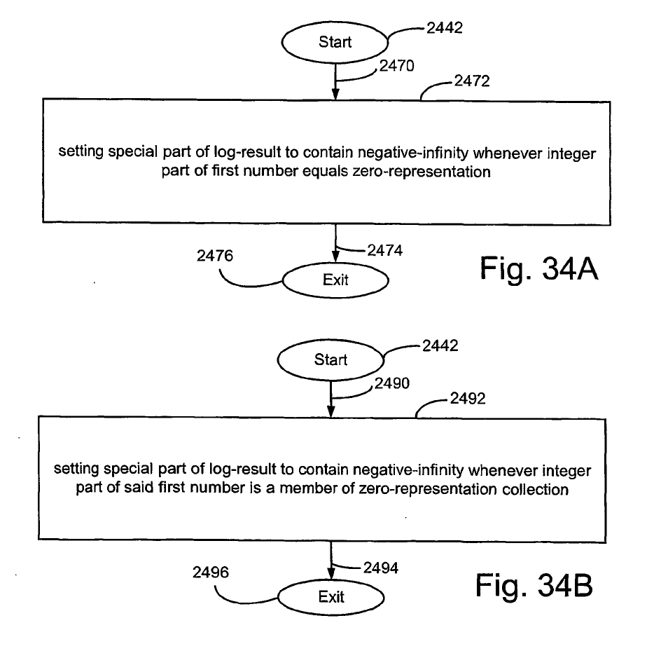

FIG. 34A depicts a detail flowchart of operation 2442 of FIG. 33B further setting the special part of the log-result.

Arrow 2470 directs the flow of execution from starting operation 2442 to operation 2472. Operation 2472 performs setting the special part of the log-result to contain the negative-infinity whenever the integer part of the first number equals the zero-representation. Arrow 2474 directs execution from operation 2472 to operation 2476. Operation 2476 terminates the operations of this flowchart.

Alternatively, the integer part of each of the number collection members may be in a redundant numeric notation possessing a zero-representation collection comprising at least two zero-representation instances.

FIG. 34B depicts a detail flowchart of operation 2442 of FIG. 33B further setting the special part of the log-result.

Arrow 2490 directs the flow of execution from starting operation 2442 to operation 2492. Operation 2492 performs setting the special part of the log-result to contain the negative-infinity whenever the integer part of the first number is a member of the zero-representation collection. Arrow 2494 directs execution from operation 2492 to operation 2496. Operation 2496 terminates the operations of this flowchart.

Note that the integer part of each member of the number collection may contains a sign and a magnitude. Further, for each member of the number collection, the sign may be a member of a sign collection consisting essentially of a positive-sign and a negative-sign.

The special part of each member of the number collection may further contain exactly one member of a second special value collection comprising a special-minus and a special-plus.

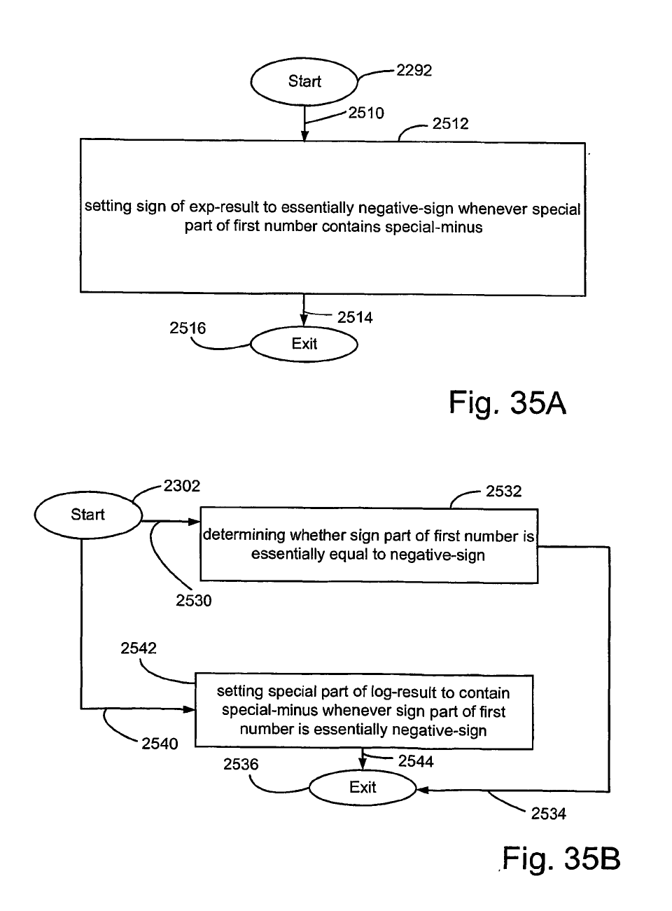

FIG. 35A depicts a detail flowchart of operation 2292 of FIG. 31 further exponentiating.

Arrow 2510 directs the flow of execution from starting operation 2292 to operation 2512. Operation 2512 performs setting the sign of the exp-result to essentially the negative-sign whenever the special part of the first number contains the special-minus. Arrow 2514 directs execution from operation 2512 to operation 2516. Operation 2516 terminates the operations of this flowchart.

FIG. 35B depicts a detail flowchart of operation 2302 of FIG. 31 further logarithming.

Arrow 2530 directs the flow of execution from starting operation 2302 to operation 2532. Operation 2532 performs determining whether the sign part of the first number is essentially equal to the negative-sign. Arrow 2534 directs execution from operation 2532 to operation 2536. Operation 2536 terminates the operations of this flowchart.

Arrow 2540 directs the flow of execution from starting operation 2302 to operation 2542. Operation 2542 performs setting the special part of the log-result to contain the special-minus whenever the sign part of the first number is essentially the negative-sign. Arrow 2544 directs execution from operation 2542 to operation 2536. Operation 2536 terminates the operations of this flowchart.

The integer part of each of the number collection members may be in a redundant numeric notation supporting determination of negativity by a negative-test collection comprising at least two negative-test steps.

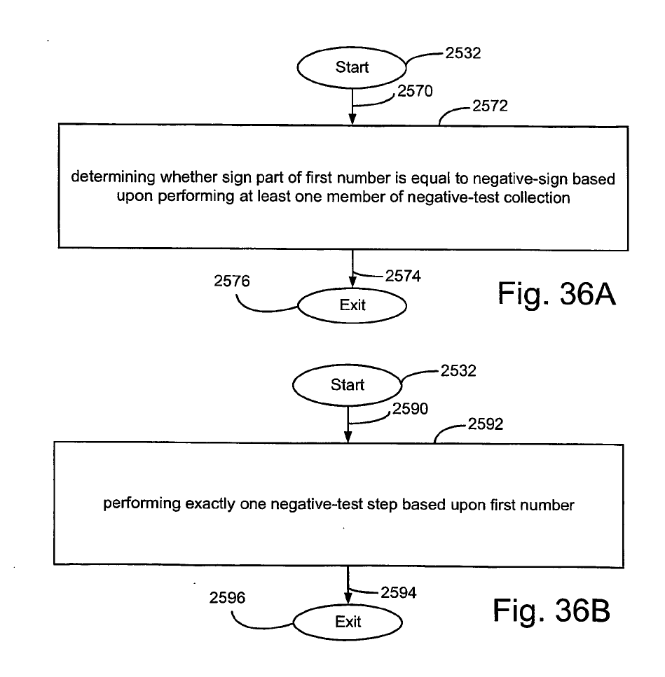

FIG. 36A depicts a detail flowchart of operation 2532 of FIG. 35B further determining whether the sign part of the first number is essentially equal to the negative-sign.

Arrow 2570 directs the flow of execution from starting operation 2532 to operation 2572. Operation 2572 performs determining whether the sign part of the first number is equal to the negative-sign based upon performing at least one of the members of the negative-test collection. Arrow 2574 directs execution from operation 2572 to operation 2576. Operation 2576 terminates the operations of this flowchart.

Alternatively, the integer part of each of the number collection members is in a non-redundant numeric notation possessing exactly one negative-test step.

FIG. 36B depicts a detail flowchart of operation 2532 of FIG. 35B further determining whether the sign part of the first number is essentially equal to the negative-sign.

Arrow 2590 directs the flow of execution from starting operation 2532 to operation 2592. Operation 2592 performs performing the exactly one negative-test step based upon the first number. Arrow 2594 directs execution from operation 2592 to operation 2596. Operation 2596 terminates the operations of this flowchart.

Note that each member of the input number collection may be comprised of an integer part.

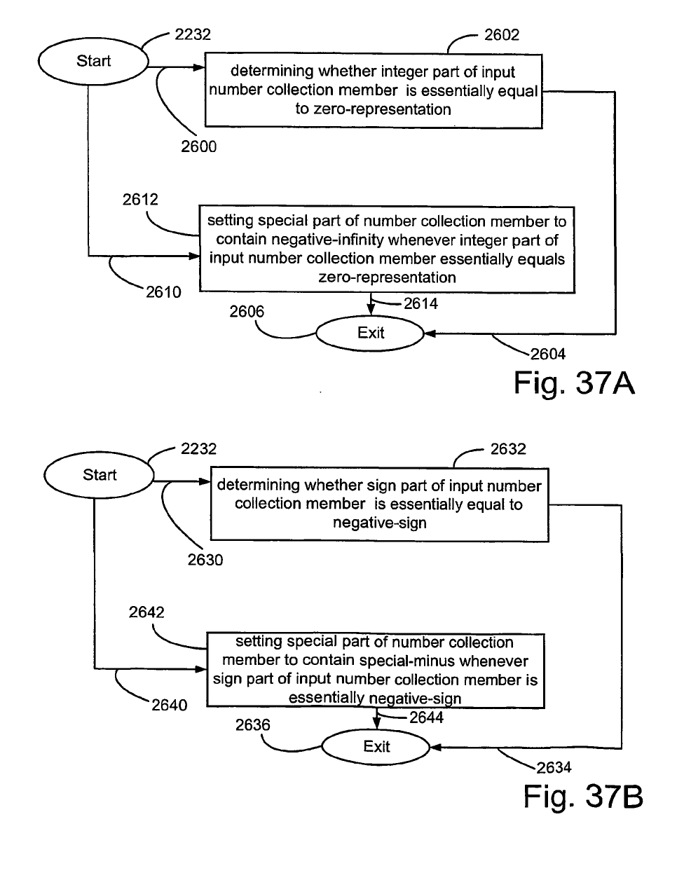

FIG. 37A depicts a detail flowchart of operation 2232 of FIG. 30 further log-converting the input number collection member.

Arrow 2600 directs the flow of execution from starting operation 2232 to operation 2602. Operation 2602 performs determining whether the integer part of the input number collection member is essentially equal to the zero-representation. Arrow 2604 directs execution from operation 2602 to operation 2606. Operation 2606 terminates the operations of this flowchart.

Arrow 2610 directs the flow of execution from starting operation 2232 to operation 2612. Operation 2612 performs setting the special part of the number collection member to contain the negative-infinity whenever the integer part of the input number collection member essentially equals the zero-representation. Arrow 2614 directs execution from operation 2612 to operation 2606. Operation 2606 terminates the operations of this flowchart.

Note that the integer part of each of the input number collection members may contain a sign belonging to the sign collection and a magnitude.

FIG. 37B depicts a detail flowchart of operation 2232 of FIG. 30 further log-converting the input number collection member.

Arrow 2630 directs the flow of execution from starting operation 2232 to operation 2632. Operation 2632 performs determining whether the sign part of the input number collection member is essentially equal to the negative-sign. Arrow 2634 directs execution from operation 2632 to operation 2636. Operation 2636 terminates the operations of this flowchart.

Arrow 2640 directs the flow of execution from starting operation 2232 to operation 2642. Operation 2642 performs setting the special part of the number collection member to contain the special-minus whenever the sign part of the input number collection member is essentially the negative-sign. Arrow 2644 directs execution from operation 2642 to operation 2636. Operation 2636 terminates the operations of this flowchart.

Note that each of the output number collection members may include a magnitude.

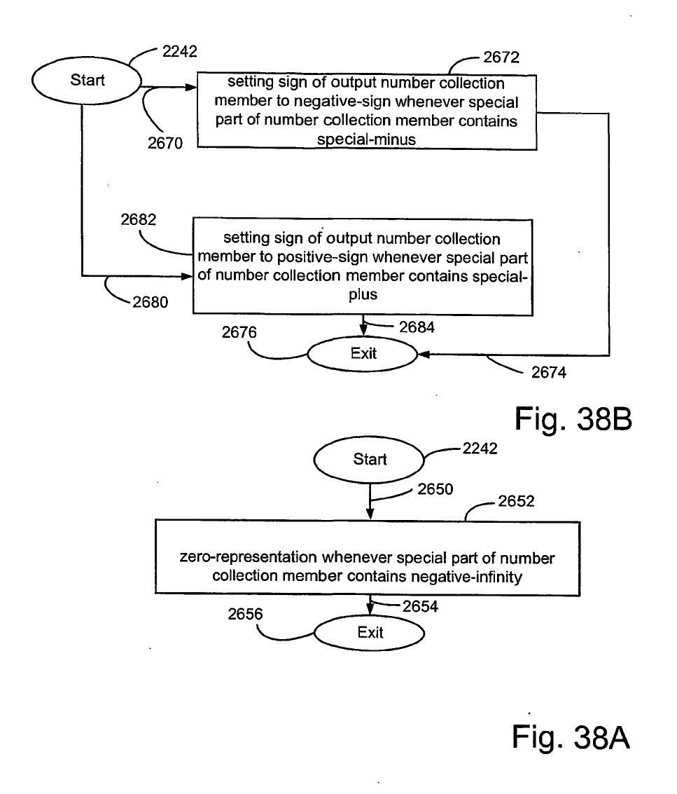

FIG. 38A depicts a detail flowchart of operation 2242 of FIG. 30 further exp-converting.

Arrow 2650 directs the flow of execution from starting operation 2242 to operation 2652. Operation 2652 performs setting the magnitude of the output number collection member to the zero-representation whenever the special part of the number collection member contains the negative-infinity. Arrow 2654 directs execution from operation 2652 to operation 2656. Operation 2656 terminates the operations of this flowchart.

Also, each of the output number collection members may include a sign belonging to the sign collection.

FIG. 38B depicts a detail flowchart of operation 2242 of FIG. 30 further exp-converting.

Arrow 2670 directs the flow of execution from starting operation 2242 to operation 2672. Operation 2672 performs setting the sign of the output number collection member to the negative-sign whenever the special part of the number collection member contains the special-minus. Arrow 2674 directs execution from operation 2672 to operation 2676. Operation 2676 terminates the operations of this flowchart.

Arrow 2680 directs the flow of execution from starting operation 2242 to operation 2682. Operation 2682 performs setting the sign of the output number collection member to the positive-sign whenever the special part of the number collection member contains the special-plus. Arrow 2684 directs execution from operation 2682 to operation 2686. Operation 2686 terminates the operations of this flowchart.

Note that each of the input number collection members may be encoded as an N1 bit code; wherein the N1 is at least three. The integer part of each of the number collection members may be encoded as an N2 bit code; wherein N2 is greater than N1.

This method of numeric processing may be implemented as a program system comprised of program steps implementing the steps of the method. The program steps may reside in a memory accessibly coupled to a computer, which executes these program steps.

The program system may further be implemented as program steps in at least one member of the language collection comprising C, C++, JAVA, FORTRAN, PASCAL, VERILOG, VHDL, assembly language and executable code for at least one computational engine implemented upon the computer.

The invention includes circuitry generated from those program steps.

The invention also includes circuitry implemented within at least one circuit component belonging to a programmable logic device collection and a fixed architecture device collection. Where the programmable logic device collection refers to all integrated circuits at least partially embodying at least one programmable logic array and all integrated circuits at least partially embodying a Field Programmable Gate Array. The fixed architecture device collection refers to all integrated circuits generated using gate array templates, fuse programmable integrated circuits, standard cell libraries, memory generators, and custom layout technologies.

The preceding embodiments of the invention have been provided by way of example and are not meant to constrain the scope of the following claims.

1. A circuit supporting partitioned operation of multiple concurrently presented instructions comprising:
a first instruction wire bundle;
a second instruction wire bundle;
a clock wire bundle possessing a capture state;
a partition control wire bundle possessing a partition control state;
an arithmetic module circuit coupled to said partition control wire bundle and further comprised of
a first memory circuit coupled to said partition control wire bundle; and
a first arithmetic logic unit coupled to said partition control wire bundle;
wherein said module circuit samples said first instruction wire bundle and said second instruction wire bundle during said capture state on said clock wire bundle respectively generating a first sampled instruction state and a second sampled instruction state; and
wherein said arithmetic module circuit responds to at least one member of a sample instruction collection based upon said partition control state;
wherein said sample instruction collection is comprised of said first sampled instruction state and to said second sampled instruction state;
wherein said arithmetic module circuit response is further comprised of:
said first memory circuit responds to at least one member of said sample instruction collection based upon said partition control state; and
said first arithmetic logic unit responds to at least one member of said sample instruction collection based upon said partition control state;
wherein said first arithmetic logic unit is further comprised of an ALU part collection comprising a first part ALU and a second part ALU;
wherein said first memory circuit is further comprised of at least two memory sub-circuits, each memory sub-circuit corresponding to a member of said ALU part collection;
wherein each member of said part ALU collection and said corresponding memory sub-circuit are coupled to said partition control wire bundle; and
wherein each member of said part ALU collection and said corresponding memory sub-circuit both respond to exactly one and the same member of said sample instruction collection based upon said partition control state.

2. The circuit of claim 1,
wherein said first part ALU presents a first carry signal to said second part ALUs;
wherein said second part ALU ignores said first carry signal whenever said exactly one sample instruction collection member for said first part ALU is different from said exactly one sample instruction collection member for said second part ALU.

3. The circuit of claim 1, further comprising:
an input-output circuit coupled to said arithmetic module circuit, to said partition control wire bundle;
wherein said input-output circuit responds to at least one member of said sample instruction collection based upon said partition control state.

4. The circuit of claim 3,
wherein said input-output circuit presents a first input to a member of the collection comprising said first ALU part and said corresponding memory sub-circuit based upon exactly one and the same member of said sample instruction collection to which said first ALU part and said corresponding memory sub-circuit respond;
wherein said input-output circuit presents a second input to a member of the collection comprising sad second ALU part and said corresponding memory sub-circuit based upon exactly one and the same member of said sample instruction collection to which said second ALU part and said corresponding memory sub-circuit respond.

5. The circuit of claim 4,
wherein said arithmetic module circuit is further comprised of a second circuit coupled to said partition control wire bundle;
wherein said second circuit is comprised of at least two second sub-circuits, each of said second sub-circuits corresponding to exactly one member of said ALU part collection;
wherein each of said second sub-circuits corresponding to said member of said ALU responds to exactly one and the same member of said sample instruction collection to which said ALU part collection member responds;
wherein for each of said second sub-circuits, said second sub-circuit further responds by approximately performing at least one member of a non-additive function collection comprising multiplication, division, square root, exponential base N, logarithm base N, sine, cosine, arcsine, arccosine, tangent, cotangent, secant, cosecant and polynomial functions based upon exactly one and the same member of said sample instruction collection to which said ALU part collection member responds;
wherein said N is a positive number.

6. The circuit of claim 5,
wherein an input collection is comprised of said first and said second input;
wherein each member of said input collection is comprised of a log-input and a normal-input;

7. The circuit of claim 6,
wherein each member of said ALU part collection presents a result to said corresponding said second sub-circuit.

8. The circuit of claim 7, further comprising
a second of said arithmetic module circuits coupled to said input-output circuit;
wherein said input-output circuit presents said first input to at least one member of the collection comprising said first ALU part of said second arithmetic module and said corresponding memory sub-circuit of said second arithmetic module based upon exactly one and the same member of said sample instruction collection to which said first ALU part of said arithmetic module circuit responds;
wherein said input-output circuit presents said second input to at least one member of the collection comprising sad second ALU part of said second arithmetic module and said corresponding memory sub-circuit of said second arithmetic module based upon exactly one and the same member of said sample instruction collection to which said second ALU part of said arithmetic module circuit responds.

9. The circuit of claim 8,
wherein a second circuit collection is comprised of said second circuit of said arithmetic module circuit and said second circuit of said second arithmetic module circuit;
wherein at least one member of said second circuit collection couples to an internal wire bundle comprised of a first sub-internal wire bundle and a second sub-internal wire bundle;
wherein for each member of said second circuit collection coupled to said internal wire bundle asserts a first sub-internal wire state on said first sub-internal wire bundle based upon said exactly one and the same member of said sample instruction collection to which said first ALU part of said arithmetic module circuit responds;
wherein for each member of said second circuit collection coupled to said internal wire bundle asserts a second sub-internal wire state on said second sub-internal wire bundle based upon said exactly one and the same member of said sample instruction collection to which said second ALU part of said arithmetic module circuit responds.

10. The circuit of claim 1, further comprising
a first datapath instruction processor coupled to said first datapath instruction wire bundle presented to said module circuit; wherein said first datapath instruction processor asserts said first datapath instruction wire bundle; and
a second datapath instruction processor coupled to said second datapath instruction wire bundle presented to said module circuit; wherein said second datapath instruction processor asserts said second datapath instruction wire bundle.

11. The circuit of claim 10,
wherein a datapath instruction processor collection is comprised of said first datapath instruction processor and said second datapath instruction processor;
wherein said first datapath instruction wire bundle is an associated datapath instruction wire bundle of said first datapath instruction processor;
wherein said second datapath instruction wire bundle is an associated datapath instruction wire bundle of said second datapath instruction processor;
wherein at least one member of said datapath instruction processor collection is further comprised of:
a datapath instruction pointer coupled to said clock wire bundle, and to a datapath instruction address wire bundle; and
a datapath instruction register coupled to said clock wire bundle, to said asserted datapath instruction wire bundle, and to a datapath instruction wire bundle;
wherein said clock wire bundle possesses a datapath instruction capture state;
wherein said datapath instruction queue pointer responds to said clock wire bundle by asserting an asserted datapath instruction address;
wherein said datapath instruction register responds to said clock wire bundle by capturing a datapath instruction capture state whenever said clock wire bundle is in said datapath instruction capture state; and
wherein said datapath instruction register further asserts said associated datapath instruction wire bundle based upon said datapath instruction capture state.

12. The circuit of claim 11,
wherein for at least one member of said datapath instruction processor collection comprising said datapath instruction pointer is further comprised of:
an instruction store coupled to said datapath instruction address wire bundle and to said datapath instruction wire bundle;
wherein said instruction store responds to said asserted datapath instruction address via said datapath instruction address wire bundle to asserting said datapath instruction wire bundle based upon said asserted datapath instruction address.

13. The circuit of claim 12,
wherein for at least one member of said datapath instruction processor collection comprising said instruction store, said datapath instruction processor is further comprised of a last instruction indicator coupled to a last instruction indicator wire bundle possessing a last instruction state and a non-last instruction state;
wherein for at least one member of said datapath instruction processor collection comprising said instruction store, said datapath instruction pointer is further coupled to a new datapath instruction address wire bundle and to said last instruction indicator wire bundle; and
wherein for at least one member of said datapath instruction processor collection comprising said instruction store is further comprised of: a branch-cache instruction processor coupled to said last instruction indicator and to said new datapath instruction address wire bundle;
wherein said branch-cache instruction processor responds to said last instruction state via said last instruction indicator wire bundle by asserting a new datapath instruction address upon said new datapath instruction address wire bundle; and
wherein said datapath instruction pointer responds to said last instruction indicator wire bundle by capturing said new datapath instruction address from said new datapath instruction address wire bundle.

14. A circuit implementation of claim 1,
wherein a component list comprises said arithmetic module circuit, said first memory circuit coupled to said partition control wire bundle, and said first arithmetic logic unit;
wherein each member of said component list is implemented with at least part of at least one member of the collection comprising a programmable logic device collection and a fixed architecture device collection;
wherein said programmable logic device collection comprises all integrated circuits at least partially embodying at least one programmable logic array and all integrated circuits at least partially embodying a Field Programmable Gate Array (FPGA); and
wherein said fixed architecture device collection comprises all integrated circuits generated using gate array templates, fuse programmable integrated circuits, standard cell libraries, memory generators, and custom layout technologies.

15. The circuit implementation of claim 14,
wherein the implementation of all members of said component list further includes only circuitry responding to said exactly one and the same member of said sample instruction collection based upon said partition control state.

16. A method of operating a module circuit containing at least an arithmetic module circuit further containing a first memory circuit and a first arithmetic logic unit using a clock wire bundle possessing a capture state and using a partition control wire bundle possessing a partition control state, said method comprising the steps of:
said module circuit sampling a first instruction pair wire bundle and a second instruction pair wire bundle during said capture state on said clock wire bundle respectively generating a first sampled instruction state and a second sampled instruction state; and
said arithmetic module circuit responding to at least one member of a sample instruction collection based upon said partition control state;
wherein said sample instruction collection is comprised of said first sampled instruction state and to said second sampled instruction state;
wherein the step of said arithmetic module circuit responding is further comprised of the steps of:
said first memory circuit responding to at least one member of said sample instruction collection based upon said partition control state; and
said first arithmetic logic unit responding to at least one member of said sample instruction collection based upon said partition control state;
wherein said first arithmetic logic unit is further comprised of an ALU part collection comprising a first part ALU and a second part ALU;
wherein the step of said first arithmetic logic unit responding is further comprised of the steps of
said first part ALU responding to exactly one member of said sample instruction collection based upon said partition control; and
said second part ALU responding to exactly one member of said sample instruction collection based upon said partition control state;
wherein said first memory circuit is comprised of at least two memory sub-circuits, each of said memory sub-circuits corresponding to a member of said ALU part collection;
wherein the step of said first memory circuit responding is further comprised of, for each of said memory sub-circuits, the step of said memory sub-circuit responding to exactly one and the same member of said sample instruction collection as said corresponding member of said ALU part collection.

17. The method of claim 16, further comprising the step of
said first part ALU presenting a first carry signal to said second part ALU;
wherein the step of said second ALU responding is comprised of the steps of:
said second part ALU ignoring said first carry signal whenever said exactly one sample instruction collection member for said first part ALU is different from said exactly one sample instruction collection member for said second part ALU.

18. The method of claim 16, further comprising the step of:
an input-output circuit responding to at least one member of said sample instruction collection based upon said partition control state.

19. The method of claim 18, further comprising the steps of:
said input-output circuit presenting a first input to a member of the collection comprising said first ALU part and said corresponding memory sub-circuit based upon exactly one and the same member of said sample instruction collection to which said first ALU part and said corresponding memory sub-circuit respond;
said input-output circuit presenting a second input to a member of the collection comprising sad second ALU part and said corresponding memory sub-circuit based upon exactly one and the same member of said sample instruction collection to which said second ALU part and said corresponding memory sub-circuit respond.

20. The method of claim 19,
wherein said arithmetic module circuit is further comprised of a second circuit coupled to said partition control wire bundle;
wherein said second circuit is comprised of at least two second sub-circuits, each of said second sub-circuits corresponding to exactly one member of said ALU part collection;
wherein said method is further comprised, for each of said second sub-circuits corresponding to said member of said ALU part collection, of the step of:
said second sub-circuit responding to exactly one and the same member of said sample instruction collection to which said ALU part collection member responds;
wherein for each of said second sub-circuits, the step of said second sub-circuit responding is further comprised of the step of:
said second sub-circuit approximately performing at least one member of a non-additive function collection comprising multiplication, division, square root, exponential base N, logarithm base N, sine, cosine, arcsine, arccosine, tangent, cotangent, secant, cosecant and polynomial functions based upon exactly one and the same member of said sample instruction collection to which said ALU part collection member responds;
wherein said N is a positive number.

21. The method of claim 20,
wherein an input collection is comprised of said first and said second input;
wherein each member of said input collection is comprised of a log-input and a normal-input.

22. The method of claim 21, further comprising the steps of:
for each member of said ALU part collection, said member presenting a result to said corresponding said second sub-circuit.

23. The method of claim 22,
wherein said module circuit is further comprised of a second of said arithmetic module circuits coupled to said input-output circuit;
wherein said method is further comprised of the step of:
said input-output circuit presenting said first input to at least one member of the collection comprising said first ALU part of said second arithmetic module and said corresponding memory sub-circuit of said second arithmetic module based upon exactly one and the same member of said sample instruction collection to which said first ALU part of said arithmetic module circuit responds;
said input-output circuit presenting said second input to at least one member of the collection comprising sad second ALU part of said second arithmetic module and said corresponding memory sub-circuit of said second arithmetic module based upon exactly one and the same member of said sample instruction collection to which said second ALU part of said arithmetic module circuit responds.

24. The method of claim 23,
wherein a second circuit collection is comprised of said second circuit of said arithmetic module circuit and said second circuit of said second arithmetic module circuit;
wherein at least one member of said second circuit collection couples to an internal wire bundle comprised of a first sub-internal wire bundle and a second sub-internal wire bundle;
wherein said method is further comprised, for each member of said second circuit collection coupled to said internal wire bundle of the step of:
said member asserting a first sub-internal wire state on said first sub-internal wire bundle based upon said exactly one and the same member of said sample instruction collection to which said first ALU part of said arithmetic module circuit responds;
said member asserting a second sub-internal wire state on said second sub-internal wire bundle based upon said exactly one and the same member of said sample instruction collection to which said second ALU part of said arithmetic module circuit responds.

25. The method of claim 16, further comprising the steps of
a first datapath instruction processor asserting said first datapath instruction wire bundle presented to said module circuit; and
a second datapath instruction processor asserting said second datapath instruction wire bundle presented to said module circuit.

26. The method of claim 25,
wherein a datapath instruction processor collection is comprised of said first datapath instruction processor and said second datapath instruction processor;
wherein said first datapath instruction wire bundle is an associated datapath instruction wire bundle of said first datapath instruction processor;
wherein said second datapath instruction wire bundle is an associated datapath instruction wire bundle of said second datapath instruction processor;
wherein at least one member of said datapath instruction processor collection is further comprised of:
a datapath instruction pointer coupled to said clock wire bundle, and to a datapath instruction address wire bundle; and
a datapath instruction register coupled to said clock wire bundle, to said asserted datapath instruction wire bundle, and to a datapath instruction wire bundle;
wherein said clock wire bundle possesses a datapath instruction capture state;
wherein said method is further comprised of the steps of said datapath instruction queue pointer responding to said clock wire bundle by asserting an asserted datapath instruction address;
said datapath instruction register responding to said clock wire bundle by capturing a datapath instruction capture state whenever said clock wire bundle is in said datapath instruction capture state; and
said datapath instruction register asserting said associated datapath instruction wire bundle based upon said datapath instruction capture state.

27. The method of claim 26,
wherein for at least one member of said datapath instruction processor collection comprising said datapath instruction pointer is further comprised of an instruction store;
wherein said method is further comprised of the steps of said instruction store responding to said asserted datapath instruction address to assert said datapath instruction wire bundle based upon said asserted datapath instruction address.

28. The method of claim 27,
wherein for at least one member of said datapath instruction processor collection comprising said instruction store, said datapath instruction processor is further comprised of a last instruction indicator coupled to a last instruction indicator wire bundle possessing a last instruction state and a non-last instruction state;
wherein for at least one member of said datapath instruction processor collection comprising said instruction store, said datapath instruction pointer is further coupled to a new datapath instruction address wire bundle and to said last instruction indicator wire bundle; and
wherein for at least one member of said datapath instruction processor collection comprising said instruction store is further comprised of: a branch-cache instruction processor coupled to said last instruction indicator and to said new datapath instruction address wire bundle;
wherein said branch-cache instruction processor responds to said last instruction state via said last instruction indicator wire bundle by asserting a new datapath instruction address upon said new datapath instruction address wire bundle; and
wherein said datapath instruction pointer responds to said last instruction indicator wire bundle by capturing said new datapath instruction address from said new datapath instruction address wire bundle.

29. A circuit implementation of the method of claim 16,
wherein the steps of the method are each implemented within at least part of at least one member of the collection comprising a programmable logic device collection and a fixed architecture device collection;
wherein said programmable logic device collection comprises all integrated circuits at least partially embodying at least one programmable logic array and all integrated circuits at least partially embodying a Field Programmable Gate Array (FPGA); and
wherein said fixed architecture device collection comprises all integrated circuits generated using gate array templates, fuse programmable integrated circuits, standard cell libraries, memory generators, and custom layout technologies.

30. A method of operating a module circuit containing at least an arithmetic module circuit further containing a first memory circuit and a first arithmetic logic unit using a clock wire bundle possessing a capture state and using a partition control wire bundle possessing a partition control state, said method comprising the steps of:
said module circuit sampling a first instruction pair wire bundle and a second instruction pair wire bundle during said capture state on said clock wire bundle respectively generating a first sampled instruction state and a second sampled instruction state; and
said arithmetic module circuit responding to at least one member of a sample instruction collection based upon said partition control state;
wherein said sample instruction collection is comprised of said first sampled instruction state and to said second sampled instruction state.

31. The method of claim 30,
wherein the step of said arithmetic module circuit responding is further comprised of the steps of:
said first memory circuit responding to at least one member of said sample instruction collection based upon said partition control state; and
said first arithmetic logic unit responding to at least one member of said sample instruction collection based upon said partition control state.

32. The method of claim 31,
wherein said first arithmetic logic unit is further comprised of an ALU part collection comprising a first part ALU and a second part ALU;
wherein the step of said first arithmetic logic unit responding is further comprised of the steps of
said first part ALU responding to exactly one member of said sample instruction collection based upon said partition control; and
said second part ALU responding to exactly one member of said sample instruction collection based upon said partition control state;
wherein said first memory circuit is comprised of at least two memory sub-circuits, each of said memory sub-circuits corresponding to a member of said ALU part collection;
wherein the step of said first memory circuit responding is further comprised of for each of said memory sub-circuits, the step of
said memory sub-circuit responding to exactly one and the same member of said sample instruction collection as said corresponding member of said ALU part collection.

33. The method of claim 32, further comprising the step of
said first part ALU presenting a first carry signal to said second part ALU;
wherein the step of said second ALU responding is comprised of the steps of:
said second part ALU ignoring said first carry signal whenever said exactly one sample instruction collection member for said first part ALU is different from said exactly one sample instruction collection member for said second part ALU.

34. The method of claim 32, further comprising the step of:
an input-output circuit responding to at least one member of said sample instruction collection based upon said partition control state.

35. The method of claim 34, further comprising the steps of:
said input-output circuit presenting a first input to a member of the collection comprising said first ALU part and said corresponding memory sub-circuit based upon exactly one and the same member of said sample instruction collection to which said first ALU part and said corresponding memory sub-circuit respond;
said input-output circuit presenting a second input to a member of the collection comprising sad second ALU part and said corresponding memory sub-circuit based upon exactly one and the same member of said sample instruction collection to which said second ALU part and said corresponding memory sub-circuit respond.

36. The method of claim 35,
wherein said arithmetic module circuit is further comprised of a second circuit coupled to said partition control wire bundle;
wherein said second circuit is comprised of at least two second sub-circuits, each of said second sub-circuits corresponding to exactly one member of said ALU part collection;
wherein said method is further comprised, for each of said second sub-circuits corresponding to said member of said ALU part collection, of the step of:
said second sub-circuit responding to exactly one and the same member of said sample instruction collection to which said ALU part collection member responds;
wherein for each of said second sub-circuits, the step of said second sub-circuit responding is further comprised of the step of:
said second sub-circuit approximately performing at least one member of a non-additive function collection comprising multiplication, division, square root, exponential base N, logarithm base N, sine, cosine, arcsine, arccosine, tangent, cotangent, secant, cosecant and polynomial functions based upon exactly one and the same member of said sample instruction collection to which said ALU part collection member responds;
wherein said N is a positive number.

37. The method of claim 36,
wherein an input collection is comprised of said first and said second input;
wherein each member of said input collection is comprised of a log-input and a normal-input.

38. The method of claim 37, further comprising the steps of:
for each member of said ALU part collection, said member presenting a result to said corresponding said second sub-circuit.

39. The method of claim 38,
wherein said module circuit is further comprised of a second of said arithmetic module circuits coupled to said input-output circuit;
wherein said method is further comprised of the step of:
said input-output circuit presenting said first input to at least one member of the collection comprising said first ALU part of said second arithmetic module and said corresponding memory sub-circuit of said second arithmetic module based upon exactly one and the same member of said sample instruction collection to which said first ALU part of said arithmetic module circuit responds;
said input-output circuit presenting said second input to at least one member of the collection comprising sad second ALU part of said second arithmetic module and said corresponding memory sub-circuit of said second arithmetic module based upon exactly one and the same member of said sample instruction collection to which said second ALU part of said arithmetic module circuit responds.

40. The method of claim 39,
wherein a second circuit collection is comprised of said second circuit of said arithmetic module circuit and said second circuit of said second arithmetic module circuit;
wherein at least one member of said second circuit collection couples to an internal wire bundle comprised of a first sub-internal wire bundle and a second sub-internal wire bundle;
wherein said method is further comprised, for each member of said second circuit collection coupled to said internal wire bundle of the step of:
said member asserting a first sub-internal wire state on said first sub-internal wire bundle based upon said exactly one and the same member of said sample instruction collection to which said first ALU part of said arithmetic module circuit responds;
said member asserting a second sub-internal wire state on said second sub-internal wire bundle based upon said exactly one and the same member of said sample instruction collection to which said second ALU part of said arithmetic module circuit responds.

41. The method of claim 30, further comprising the steps of
a first datapath instruction processor asserting said first datapath instruction wire bundle presented to said module circuit; and
a second datapath instruction processor asserting said second datapath instruction wire bundle presented to said module circuit.

42. The method of claim 41,
wherein a datapath instruction processor collection is comprised of said first datapath instruction processor and said second datapath instruction processor;
wherein said first datapath instruction wire bundle is an associated datapath instruction wire bundle of said first datapath instruction processor;
wherein said second datapath instruction wire bundle is an associated datapath instruction wire bundle of said second datapath instruction processor;
wherein at least one member of said datapath instruction processor collection is further comprised of:
a datapath instruction pointer coupled to said clock wire bundle, and to a datapath instruction address wire bundle; and
a datapath instruction register coupled to said clock wire bundle, to said asserted datapath instruction wire bundle, and to a datapath instruction wire bundle;
wherein said clock wire bundle possesses a datapath instruction capture state;
wherein said method is further comprised of the steps of said datapath instruction queue pointer responding to said clock wire bundle by asserting an asserted datapath instruction address;
said datapath instruction register responding to said clock wire bundle by capturing a datapath instruction capture state whenever said clock wire bundle is in said datapath instruction capture state; and
said datapath instruction register asserting said associated datapath instruction wire bundle based upon said datapath instruction capture state.

43. The method of claim 42,
wherein for at least one member of said datapath instruction processor collection comprising said datapath instruction pointer is further comprised of an instruction store;
wherein said method is further comprised of the steps of
said instruction store responding to said asserted datapath instruction address to assert said datapath instruction wire bundle based upon said asserted datapath instruction address.

44. The method of claim 43,
wherein for at least one member of said datapath instruction processor collection comprising said instruction store, said datapath instruction processor is further comprised of a last instruction indicator coupled to a last instruction indicator wire bundle possessing a last instruction state and a non-last instruction state;
wherein for at least one member of said datapath instruction processor collection comprising said instruction store, said datapath instruction pointer is further coupled to a new datapath instruction address wire bundle and to said last instruction indicator wire bundle, and
wherein for at least one member of said datapath instruction processor collection comprising said instruction store is further comprised of: a branch-cache instruction processor coupled to said last instruction indicator and to said new datapath instruction address wire bundle;
wherein said branch-cache instruction processor responds to said last instruction state via said last instruction indicator wire bundle by asserting a new datapath instruction address upon said new datapath instruction address wire bundle; and
wherein said datapath instruction pointer responds to said last instruction indicator wire bundle by capturing said new datapath instruction address from said new datapath instruction address wire bundle.

45. A circuit implementation of the method of claim 30,
wherein the steps of the method are each implemented within at least part of at least one member of the collection comprising a programmable logic device collection and a fixed architecture device collection;
wherein said programmable logic device collection comprises all integrated circuits at least partially embodying at least one programmable logic array and all integrated circuits at least partially embodying a Field Programmable Gate Array (FPGA); and
wherein said fixed architecture device collection comprises all integrated circuits generated using gate array templates, fuse programmable integrated circuits, standard cell libraries, memory generators, and custom layout technologies.

46. A circuit supporting partitioned operation of multiple concurrently presented instructions comprising:
a first instruction wire bundle;
a second instruction wire bundle;
a clock wire bundle possessing a capture state;
a partition control wire bundle possessing a partition control state;
an arithmetic module circuit coupled to said partition control wire bundle and further comprised of
a first memory circuit coupled to said partition control wire bundle; and
a first arithmetic logic unit coupled to said partition control wire bundle;
wherein said module circuit samples said first instruction wire bundle and said second instruction wire bundle during said capture state on said clock wire bundle respectively generating a first sampled instruction state and a second sampled instruction state; and
wherein said arithmetic module circuit responds to at least one member of a sample instruction collection based upon said partition control state;
wherein said sample instruction collection is comprised of said first sampled instruction state and to said second sampled instruction state.

47. The circuit of claim 46,
wherein said arithmetic module circuit response is further comprised of:
said first memory circuit responds to at least one member of said sample instruction collection based upon said partition control state; and
said first arithmetic logic unit responds to at least one member of said sample instruction collection based upon said partition control state.

48. The circuit of claim 47,
wherein said first arithmetic logic unit is further comprised of an ALU part collection comprising a first part ALU and a second part ALU;
wherein said first memory circuit is further comprised of at least two memory sub-circuits, each memory sub-circuit corresponding to a member of said ALU part collection;
wherein each member of said part ALU collection and said corresponding memory sub-circuit are coupled to said partition control wire bundle; and
wherein each member of said part ALU collection and said corresponding memory sub-circuit both respond to exactly one and the same member of said sample instruction collection based upon said partition control state.

49. The circuit of claim 48,
wherein said partition control state includes to a carry partition control belonging to a partition control state collection comprising first carry control state and a second carry control state;
wherein said first part ALU presents a first carry signal to said second part ALUs;
wherein said second part ALU ignores said first carry signal whenever said exactly one sample instruction collection member for said first part ALU is different from said exactly one sample instruction collection member for said second part ALU.

50. The circuit of claim 48, further comprising:
an input-output circuit coupled to said arithmetic module circuit, to said partition control wire bundle;
wherein said input-output circuit responds to at least one member of said sample instruction collection based upon said partition control state.

51. The circuit of claim 50,
wherein said input-output circuit presents a first input to a member of the collection comprising said first ALU part and said corresponding memory sub-circuit based upon exactly one and the same member of said sample instruction collection to which said first ALU part and said corresponding memory sub-circuit respond;
wherein said input-output circuit presents a second input to a member of the collection comprising sad second ALU part and said corresponding memory sub-circuit based upon exactly one and the same member of said sample instruction collection to which said second ALU part and said corresponding memory sub-circuit respond.

52. The circuit of claim 51,
wherein said arithmetic module circuit is further comprised of a second circuit coupled to said partition control wire bundle;
wherein said second circuit is comprised of at least two second sub-circuits, each of said second sub-circuits corresponding to exactly one member of said ALU part collection;
wherein each of said second sub-circuits corresponding to said member of said ALU responds to exactly one and the same member of said sample instruction collection to which said ALU part collection member responds;
wherein for each of said second sub-circuits, said second sub-circuit further responds by approximately performing at least one member of a non-additive function collection comprising multiplication, division, square root, exponential base N, logarithm base N, sine, cosine, arcsine, arccosine, tangent, cotangent, secant, cosecant and polynomial functions based upon exactly one and the same member of said sample instruction collection to which said ALU part collection member responds;
wherein said N is a positive number.

53. The circuit of claim 52,
wherein an input collection is comprised of said first and said second input;
wherein each member of said input collection is comprised of a log-input and a normal-input;

54. The circuit of claim 53,
wherein each member of said ALU part collection presents a result to said corresponding said second sub-circuit.

55. The circuit of claim 54, further comprising
a second of said arithmetic module circuits coupled to said input-output circuit;
wherein said input-output circuit presents said first input to at least one member of the collection comprising said first ALU part of said second arithmetic module and said corresponding memory sub-circuit of said second arithmetic module based upon exactly one and the same member of said sample instruction collection to which said first ALU part of said arithmetic module circuit responds;
wherein said input-output circuit presents said second input to at least one member of the collection comprising sad second ALU part of said second arithmetic module and said corresponding memory sub-circuit of said second arithmetic module based upon exactly one and the same member of said sample instruction collection to which said second ALU part of said arithmetic module circuit responds.

56. The circuit of claim 55,
wherein a second circuit collection is comprised of said second circuit of said arithmetic module circuit and said second circuit of said second arithmetic module circuit;
wherein at least one member of said second circuit collection couples to an internal wire bundle comprised of a first sub-internal wire bundle and a second sub-internal wire bundle;
wherein for each member of said second circuit collection coupled to said internal wire bundle asserts a first sub-internal wire state on said first sub-internal wire bundle based upon said exactly one and the same member of said sample instruction collection to which said first ALU part of said arithmetic module circuit responds;
wherein for each member of said second circuit collection coupled to said internal wire bundle asserts a second sub-internal wire state on said second sub-internal wire bundle based upon said exactly one and the same member of said sample instruction collection to which said second ALU part of said arithmetic module circuit responds.

57. The circuit of claim 46, further comprising
a first datapath instruction processor coupled to said first datapath instruction wire bundle presented to said module circuit; wherein said first datapath instruction processor asserts said first datapath instruction wire bundle; and
a second datapath instruction processor coupled to said second datapath instruction wire bundle presented to said module circuit; wherein said second datapath instruction processor asserts said second datapath instruction wire bundle.

58. The circuit of claim 57,
wherein a datapath instruction processor collection is comprised of said first datapath instruction processor and said second datapath instruction processor;
wherein said first datapath instruction wire bundle is an associated datapath instruction wire bundle of said first datapath instruction processor;
wherein said second datapath instruction wire bundle is an associated datapath instruction wire bundle of said second datapath instruction processor;
wherein at least one member of said datapath instruction processor collection is further comprised of:
a datapath instruction pointer coupled to said clock wire bundle, and to a datapath instruction address wire bundle; and
a datapath instruction register coupled to said clock wire bundle, to said asserted datapath instruction wire bundle, and to a datapath instruction wire bundle;
wherein said clock wire bundle possesses a datapath instruction capture state;
wherein said datapath instruction queue pointer responds to said clock wire bundle by asserting an asserted datapath instruction address;
wherein said datapath instruction register responds to said clock wire bundle by capturing a datapath instruction capture state whenever said clock wire bundle is in said datapath instruction capture state; and
wherein said datapath instruction register further asserts said associated datapath instruction wire bundle based upon said datapath instruction capture state.

59. The circuit of claim 58,
wherein for at least one member of said datapath instruction processor collection comprising said datapath instruction pointer is further comprised of:
an instruction store coupled to said datapath instruction address wire bundle and to said datapath instruction wire bundle;
wherein said instruction store responds to said asserted datapath instruction address via said datapath instruction address wire bundle to asserting said datapath instruction wire bundle based upon said asserted datapath instruction address.

60. The circuit of claim 59,
wherein for at least one member of said datapath instruction processor collection comprising said instruction store, said datapath instruction processor is further comprised of a last instruction indicator coupled to a last instruction indicator wire bundle possessing a last instruction state and a non-last instruction state;
wherein for at least one member of said datapath instruction processor collection comprising said instruction store, said datapath instruction pointer is further coupled to a new datapath instruction address wire bundle and to said last instruction indicator wire bundle; and
wherein for at least one member of said datapath instruction processor collection comprising said instruction store is further comprised of: a branch-cache instruction processor coupled to said last instruction indicator and to said new datapath instruction address wire bundle;
wherein said branch-cache instruction processor responds to said last instruction state via said last instruction indicator wire bundle by asserting a new datapath instruction address upon said new datapath instruction address wire bundle; and
wherein said datapath instruction pointer responds to said last instruction indicator wire bundle by capturing said new datapath instruction address from said new datapath instruction address wire bundle.

61. A circuit implementation of claim 46,
wherein a component list comprises said arithmetic module circuit, said first memory circuit coupled to said partition control wire bundle, and said first arithmetic logic unit;
wherein each member of said component list is implemented with at least part of at least one member of the collection comprising a programmable logic device collection and a fixed architecture device collection;
wherein said programmable logic device collection comprises all integrated circuits at least partially embodying at least one programmable logic array and all integrated circuits at least partially embodying a Field Programmable Gate Array (FPGA); and
wherein said fixed architecture device collection comprises all integrated circuits generated using gate array templates, fuse programmable integrated circuits, standard cell libraries, memory generators, and custom layout technologies.

62. The circuit implementation of claim 61,:
wherein the implementation of all members of said component list further includes only circuitry responding to exactly one and the same member of said sample instruction collection based upon said partition control state.

63. A method of processing numeric data, comprising the step of:
representing each member of a number collection by an integer part and a special part;
log-converting a member of an input number collection to create a member of said number collection; and
exp-converting a member of said number collection to create a member of an output number collection;
wherein said special part representing said member of said number collection contains of exactly one member of a first special value collection comprising negative-infinity and not-negative-infinity;
wherein said special part of each member of said number collection further contains exactly one member of a second special value collection comprising a special-minus and a special-plus;
wherein said integer part of each member of said number collection contains a sign and a magnitude;
wherein, for each member of said number collection, said sign is a member of a sign collection consisting essentially of a positive-sign and a negative-sign;
wherein said number collection comprises at least a first number and a second number;
said method further comprising the steps of: performing all members of the arithmetic operation collection upon at least one of said members of said number collection;
wherein said arithmetic operation collection is comprised of the steps of:
adding said first number to said second number to create an add-result;
subtracting said first number by said second number to create a subtract-result;
exponentiating said first number to create an exp-result; and
logarithming said first number to create a log-result;
wherein said number collection is further comprised of said add-result, said subtract-result, said exp-result and said log-result;
wherein the step of adding is further comprised of the steps of:
determining whether said special part of said first number contains said negative-infinity;
determining whether said special part of said second number contains said negative-infinity; and
setting said special part of said add-result to contain said negative-infinity whenever said special part of at least one member of the collection said first number and said second number contains said negative-infinity;
wherein the step of subtracting is further comprised of the steps of:
determining whether said special part of said first number contains said negative-infinity;
setting said special part of said subtract-result to contain said negative-infinity whenever said special part of said first number contains said negative-infinity; wherein the step of exponentiating is further comprised of the step of:
determining whether said special part of said first number contains said negative-infinity;
setting said special part of said exp-result to contain said not-negative-infinity and setting said integer part to a zero-representation whenever said special part of said first number contains said negative-infinity; and
setting said sign of said exp-result to essentially said negative-sign whenever said special part of said first number contains said special-minus;
wherein the step of logarithming is further comprised of the steps of:
determining whether said integer part of said first number is essentially equal to said zero-representation;
setting said special part of said log-result to contain said negative-infinity whenever said integer part of said first number essentially equals said zero-representation;
determining whether said sign part of said first number is essentially equal to said negative-sign; and
setting said special part of said log-result to contain said special-minus whenever said sign part of said first number is essentially said negative-sign;
wherein said input number collection is comprised of a first input number and a second input number.
wherein each member of said input number collection is comprised of an integer part;
wherein the step log-converting said input number collection member is further comprised of the steps of:
determining whether said integer part of said input number collection member is essentially equal to said zero-representation; and
setting said special part of said number collection member to contain said negative-infinity whenever said integer part of said input number collection member essentially equals said zero-representation.
wherein said output number collection is comprised of a first output number and a second output number;
wherein each of said output number collection members include a magnitude;
wherein the step exp-converting is further comprised of the steps of:
setting said magnitude of said output number collection member to said zero-representation whenever said special part of said number collection member contains said negative-infinity; and
setting said sign of said output number collection member to said positive-sign whenever said special part of said number collection member contains said special-plus.

64. The method of claim 63,
wherein said integer part of each of said number collection members is in a non-redundant numeric notation;
wherein the step of setting said special part of said log-result is further comprised of the step of:
setting said special part of said log-result to contain said negative-infinity whenever said integer part of said first number equals said zero-representation.

65. The method of claim 63,
wherein said integer part of each of said number collection members is in a redundant numeric notation possessing a zero-representation collection comprising at least two zero-representation instances;
wherein the step of setting said special part of said log-result is further comprised of the step of:
setting said special part of said log-result to contain said negative-infinity whenever said integer part of said first number is a member of said zero-representation collection.

66. The method of claim 63,
wherein said integer part of each of said number collection members is in a redundant numeric notation supporting determination of negativity by a negative-test collection comprising at least two negative-test steps;
where the step determining whether said sign part of said first number is essentially equal to said negative-sign is further comprised of the step of:
determining whether said sign part of said first number is equal to said negative-sign based upon performing at least one of the members of said negative-test collection.

67. The method of claim 63,
wherein said integer part of each of said number collection members is in a non-redundant numeric notation possessing exactly one negative-test step;
wherein the step of determining whether said sign part of said first number is essentially equal to said negative-sign is further comprised of the step of:
performing said exactly one negative-test step based upon said first number.

68. The method of claim 63,
wherein said integer part of each of said input number collection members contains a sign belonging to said sign collection and a magnitude;
wherein the step of log-converting is further comprised of the steps of:
determining whether said sign part of said input number collection member is essentially equal to said negative-sign; and
setting said special part of said number collection member to contain said special-minus whenever said sign part of said input number collection member is essentially said negative-sign.

69. The method of claim 63,
wherein each of said output number collection members include a sign belong to said sign collection;
wherein the step exp-converting is further comprised of the step of:
setting said sign of said output number collection member to said negative-sign whenever said special part of said number collection member contains said special-minus.

70. The method of claim 69,
wherein each of said input number collection members is encoded as an N1 bit code; wherein said N1 is at least three;
wherein said integer part of each of said number collection members is encoded as an N2 bit code; wherein N2 is greater than N1.

71. A program system for processing numeric data, implementing the steps of claim 63, comprising program steps residing in a memory accessibly coupled to a computer, said program system comprising the program steps of:
representing each member of a number collection by an integer part and a special part;
log-converting a member of an input number collection to create a member of said number collection;
exp-converting a member of said number collection to create a member of an output number collection;
determining whether said special part of said first number contains said negative-infinity;
adding said first number to said second number to create an add-result;
subtracting said first number by said second number to create a subtract-result;
exponentiating said first number to create an exp-result; and
logarithming said first number to create a log-result.

72. The program system of claim 71,
wherein the program steps implementing the method are embodied in at least one member of the language collection comprising C, C++, JAVA, FORTRAN, PASCAL, VERILOG, VHDL, assembly language and executable code for at least one computational engine implemented upon said computer.

73. A digital circuit generated from the program steps of claim 72.

74. A circuit for processing numeric data, implementing the steps of claim 63, comprising:
means for representing each member of a number collection by an integer part and a special part;
means for determining whether said special part of said first number contains said negative-infinity;
means for adding said first number to said second number to create an add-result;
means for subtracting said first number by said second number to create a subtract-result;
means for exponentiating said first number to create an exp-result; and
means for logarithming said first number to create a log-result.

75. The circuit of claim 74,
wherein at least one of the means of claim 74 is implemented within at least one circuit component belonging to a programmable logic device collection and a fixed architecture device collection;
wherein said programmable logic device collection comprises all integrated circuits at least partially embodying at least one programmable logic array and all integrated circuits at least partially embodying a Field Programmable Gate Array; and
wherein said fixed architecture device collection comprises all integrated circuits generated using gate array templates, fuse programmable integrated circuits, standard cell libraries, memory generators, and custom layout technologies.

76. The circuit of claim 74,
wherein at least one of said input number collection members are implemented as a wire state collection received from a wire bundle coupled to said circuit.

77. The circuit of claim 74,
wherein at least one of said output number collection members are implemented as a wire state asserted by said circuit onto a wire bundle.

78. A method of processing numeric data, comprising the step of:
representing each member of a number collection by an integer part and a special part;
wherein said special part representing said member of said number collection contains of exactly one member of a first special value collection comprising negative-infinity and not-negative-infinity;
wherein said number collection comprises at least a first number and a second number;
said method further comprising the steps of: performing at least one member of the arithmetic operation collection upon at least one of said members of said number collection;
wherein said arithmetic operation collection is comprised of the steps of:
adding said first number to said second number to create an add-result;
subtracting said first number by said second number to create a subtract-result;
exponentiating said first number to create an exp-result; and
logarithming said first number to create a log-result;
wherein said number collection is further comprised of said add-result, said subtract-result, said exp-result and said log-result;
wherein the step of adding is further comprised of the steps of:
determining whether said special part of said first number contains said negative-infinity;
determining whether said special part of said second number contains said negative-infinity; and
setting said special part of said add-result to contain said negative-infinity whenever said special part of at least one member of the collection said first number and said second number contains said negative-infinity;
wherein the step of subtracting is further comprised of the steps of:
determining whether said special part of said first number contains said negative-infinity;
setting said special part of said subtract-result to contain said negative-infinity whenever said special part of said first number contains said negative-infinity;
wherein the step of exponentiating is further comprised of the step of:
determining whether said special part of said first number contains said negative-infinity;
setting said special part of said exp-result to contain said not-negative-infinity and setting said integer part to a zero-representation whenever said special part of said first number contains said negative-infinity;
wherein the step of logarithming is further comprised of the steps of:
determining whether said integer part of said first number is essentially equal to said zero-representation; and
setting said special part of said log-result to contain said negative-infinity whenever said integer part of said first number essentially equals said zero-representation.

79. The method of claim 78,
wherein said integer part of each of said number collection members is in a non-redundant numeric notation;
wherein the step of setting said special part of said log-result is further comprised of the step of:
setting said special part of said log-result to contain said negative-infinity whenever said integer part of said first number equals said zero-representation.

80. The method of claim 78,
wherein said integer part of each of said number collection members is in a redundant numeric notation possessing a zero-representation collection comprising at least two zero-representation instances;
wherein the step of setting said special part of said log-result is further comprised of the step of:
setting said special part of said log-result to contain said negative-infinity whenever said integer part of said first number is a member of said zero-representation collection.

81. The method of claim 78,
wherein said integer part of each member of said number collection contains a sign and a magnitude;
wherein, for each member of said number collection, said sign is a member of a sign collection consisting essentially of a positive-sign and a negative-sign;
wherein said special part of each member of said number collection further contains exactly one member of a second special value collection comprising a special-minus and a special-plus;
wherein the step of exponentiating is further comprised of the steps of:
setting said sign of said exp-result to essentially said negative-sign whenever said special part of said first number contains said special-minus;
wherein the step of logarithming is further comprised of the steps of:
determining whether said sign part of said first number is essentially equal to said negative-sign; and
setting said special part of said log-result to contain said special-minus whenever said sign part of said first number is essentially said negative-sign.

82. The method of claim 81,
wherein said integer part of each of said number collection members is in a redundant numeric notation supporting determination of negativity by a negative-test collection comprising at least two negative-test steps;
where the step determining whether said sign part of said first number is essentially equal to said negative-sign is further comprised of the step of:
determining whether said sign part of said first number is equal to said negative-sign based upon performing at least one of the members of said negative-test collection.

83. The method of claim 81,
wherein said integer part of each of said number collection members is in a non-redundant numeric notation possessing exactly one negative-test step;
wherein the step of determining whether said sign part of said first number is essentially equal to said negative-sign is further comprised of the step of:
performing said exactly one negative-test step based upon said first number.

84. The method of claim 81, further comprising the step of:
log-converting a member of an input number collection to create a member of said number collection;
wherein said input number collection is comprised of a first input number and a second input number.

85. The method of claim 84,
wherein each member of said input number collection is comprised of an integer part;
wherein the step log-converting said input number collection member is further comprised of the steps of:
determining whether said integer part of said input number collection member is essentially equal to said zero-representation; and
setting said special part of said number collection member to contain said negative-infinity whenever said integer part of said input number collection member essentially equals said zero-representation.

86. The method of claim 85,
wherein said integer part of each of said input number collection members contains a sign belonging to said sign collection and a magnitude;
wherein the step of log-converting is further comprised of the steps of:
determining whether said sign part of said input number collection member is essentially equal to said negative-sign; and
setting said special part of said number collection member to contain said special-minus whenever said sign part of said input number collection member is essentially said negative-sign.

87. The method of claim 86, further comprising the step of:
exp-converting a member of said number collection to create a member of an output number collection;
wherein said output number collection is comprised of a first output number and a second output number.

88. The method of claim 87,
wherein each of said output number collection members include a magnitude;
wherein the step exp-converting is further comprised of the step of:
setting said magnitude of said output number collection member to said zero-representation whenever said special part of said number collection member contains said negative-infinity.

89. The method of claim 88,
wherein each of said output number collection members include a sign belong to said sign collection;
wherein the step exp-converting is further comprised of the steps of:
setting said sign of said output number collection member to said negative-sign whenever said special part of said number collection member contains said special-minus; and
setting said sign of said output number collection member to said positive-sign whenever said special part of said number collection member contains said special-plus.

90. The method of claim 89,
wherein each of said input number collection members is encoded as an N1 bit code; wherein said N1 is at least three;
wherein said integer part of each of said number collection members is encoded as an N2 bit code; wherein N2 is greater than N1.

91. A program system for processing numeric data, implementing the steps of claim 78, comprising program steps residing in a memory accessibly coupled to a computer, said program system comprising the program steps of:
representing each member of a number collection by an integer part and a special part;
adding said first number to said second number to create an add-result;
subtracting said first number by said second number to create a subtract-result;
exponentiating said first number to create an exp-result; and
logarithming said first number to create a log-result.

92. The program system of claim 78,
wherein the program steps implementing the method are embodied in at least one member of the language collection comprising C, C++, JAVA, FORTRAN, PASCAL, VERILOG, VHDL, assembly language and executable code for at least one computational engine implemented upon said computer.

93. A circuit generated from the program steps of claim 92.

94. A circuit for processing numeric data, implementing the steps of claim 78, comprising:
means for representing each member of a number collection by an integer part and a special part;
means for adding said first number to said second number to create an add-result;
means for subtracting said first number by said second number to create a subtract-result;
means for exponentiating said first number to create an exp-result; and
means for logarithming said first number to create a log-result.

95. The circuit of claim 94,
wherein at least one of the means of claim 94 is implemented within at least one circuit component belonging to a programmable logic device collection and a fixed architecture device collection;
wherein said programmable logic device collection comprises all integrated circuits at least partially embodying at least one programmable logic array and all integrated circuits at least partially embodying a Field Programmable Gate Array; and
wherein said fixed architecture device collection comprises all integrated circuits generated using gate array templates, fuse programmable integrated circuits, standard cell libraries, memory generators, and custom layout technologies.

96. The circuit of claim 94,
wherein at least one of said input number collection members are implemented as a wire state collection received from a wire bundle coupled to said circuit.

97. The circuit of claim 94,
wherein at least one of said output number collection members are implemented as a wire state asserted by said circuit onto a wire bundle.
